(19) United States
(12) Patent Application Publication
(10) Pub. No.: US 2020/0171831 A1
(43) Pub. Date: Jun. 4, 2020

(54) SKIN PRINTER

(71) Applicant: PRINKER KOREA INC., Suwon-si (KR)

(72) Inventors: Jong In LEE, Suwon-si (KR); Tae Sik YUN, Seoul (KR); Kyu Suk LEE, Suwon-si (KR)

(73) Assignee: PRINKER KOREA INC., Suwon-si (KR)

(21) Appl. No.: 16/781,831

(22) Filed: Feb. 4, 2020

Related U.S. Application Data
(63) Continuation of application No. PCT/KR2017/012831, filed on Nov. 14, 2017.

(30) Foreign Application Priority Data
Sep. 8, 2017 (KR) 10-2017-0115000
Oct. 20, 2017 (KR) 10-2017-0136783
Oct. 20, 2017 (KR) 10-2017-0136784
Oct. 20, 2017 (KR) 10-2017-0136785
Oct. 20, 2017 (KR) 10-2017-0136786
Oct. 20, 2017 (KR) 10-2017-0136787
Oct. 20, 2017 (KR) 10-2017-0136788

(51) Int. Cl. B41J 2/165; B41J 3/36; B41M 5/00

(52) U.S. Cl. CPC B41J 2/16535; B41M 5/0076; B41J 3/36

(57) ABSTRACT

A skin printer includes a printer housing including a receiving part to receive a plurality of cartridges having a nozzle to discharge a printing solution including at least one of an ink, a coating agent, a fragrant material, and a fluorescent substance or a combination of the ink, the coating agent, the fragrant material, and the fluorescent substance, and a plurality of discharge holes to discharge the printing solution from nozzles of the plurality of cartridges received in the receiving part, a main roller rollably provided in the printer housing to guide movement of the printer housing along a skin, and at least one spacing roller interposed between the discharge holes paired to be adjacent to each other to space the printer housing to the skin, and to roll along the skin together with the main roller.

### CROSS-REFERENCE TO RELATED APPLICATIONS

The present application is a continuation of International Patent Application No. PCT/KR2017/012831, Nov. 14, 2017 which is based upon and claims the benefit of priority to Korean Patent Application Nos. 10-2017-0115000 filed on Sep. 8, 2017, 10-2017-0136783, 10-2017-0136784, 10-2017-0136785, 10-2017-0136786, 10-2017-0136787 and 10-2017-0136788 filed on Oct. 20, 2017. The disclosures of the above-listed applications are hereby incorporated by reference herein in their entirety.

### BACKGROUND

Embodiments of the inventive concept described herein relate to a skin printer, and more particularly, to a skin printer capable of printing a tattoo image on a skin and a method for controlling the same.

Recently, as interest in tattoos and body painting increases, the demand for printers, which are able to print the tattoos and the body paining on a skin, increases.

Since the tattoos or body paintings have to be operated by the sophisticated person, the accessibility to the tattoos or the body painting may be lowered.

Meanwhile, when a mobile printer is used, a user may easily print various desired images on the skin.

However, since the mobile printer performs printing for the skin, the mobile printer may make the significant difference between an original print image, which is desired by the user, and the printout.

In detail, the conventional mobile printer may make the difference in color between the original image and the printout due to the color and the condition of a person skin, which serves as a background.

Therefore, the present applicant has developed a skin printer, in which a user may move the skin printer along a skin for printing while holding the skin printer and may print a desired image on the skin by discharging a printing solution from a nozzle of a cartridge having the printing solution.

### SUMMARY

The inventive concept provides a skin printer capable of preventing a printing solution from being spread on a skin in skin printing and of printing an image on the skin such that the image is similar to an original image.

The technical objects of the inventive concept are not limited to the above-mentioned ones, and the other unmentioned technical objects will become apparent to those skilled in the art from the following description.

In accordance with an aspect of the inventive concept, there is provided a skin printer comprising a printer housing including a receiving part to receive a plurality of cartridges having a nozzle to discharge a printing solution including at least one of an ink, a coating agent, a fragrant material, and a fluorescent substance or a combination of the ink, the coating agent, the fragrant material, and the fluorescent substance, and a plurality of discharge holes to discharge the printing solution from nozzles of the plurality of cartridges received in the receiving part, a main roller rollably provided in the printer housing to guide movement of the printer housing along a skin, and at least one spacing roller interposed between the discharge holes paired to be adjacent to each other to space the printer housing to the skin, and to roll along the skin together with the main roller.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view illustrating a skin printer, according to an embodiment of the inventive concept;

FIG. 2 is a bottom perspective view illustrating that a cover of the skin printer of FIG. 1 is positioned in a first position;

FIG. 3 is a bottom perspective view illustrating that the cover of the skin printer of FIG. 1 is positioned in a second position;

FIG. 4 is a rear perspective view illustrating the cover of FIG. 1;

FIG. 5 is a view illustrating a roller lifter, according to an embodiment;

FIG. 6 is an enlarged perspective view illustrating a main component of the roller lifter of FIG. 5;

FIGS. 7 and 8 are views illustrating that the roller lifter is moved up and down;

FIGS. 9 and 10 are views illustrating that the roller lifter is moved up and down, according to another embodiment;

FIG. 11 is a view illustrating a method for measuring the spacing from a skin by the skin printer, according to an embodiment;

FIG. 12 is a view illustrating the configuration of the skin printer illustrating a method for controlling the roller to be moved up and down, according to an embodiment of the inventive concept;

FIG. 13 is a perspective view illustrating a docking station for a skin printer, according to an embodiment of the inventive concept;

FIG. 14 is a sectional view taken along line A-A of FIG. 1;

FIG. 15 is a view illustrating the state that a docking station for the skin printer is coupled to the skin printer, according to an embodiment of the inventive concept;

FIG. 16 is an exploded perspective view of FIG. 15;

FIG. 17 is a view illustrating a skin printer system, according to an embodiment;

FIG. 18 is a flowchart illustrating a method for guiding an output of a skin printer by a computer according to an embodiment;

FIG. 19 is a view illustrating that a skin printer outputs an image to a body of a user;

FIG. 20 illustrates that a user client captures a body part of a user;

FIG. 21 is a view illustrating that the user client displays a simulation image;

FIG. 22 is a view illustrating that the skin printer projects a guidance indicating the output start position and the output direction of the skin printer on one position on the body part;

FIG. 23 is a view illustrating that the skin printer projects the output result of the skin printer on one position of the body part;

FIG. 24 illustrates that the user client splits an image;

FIG. 25 illustrates that the skin printer outputs a plurality of layers on the body part;

FIG. 26 is a flowchart illustrating a nightglow skin printing method.

FIG. 27 illustrates that a user client inverts an image;

FIG. 28 illustrates that a nightglow coating agent is applied, an inverted image is output on the nightglow coating agent, and a nightglow image is output;

FIG. 29 illustrates a method for recognizing an area coated with a nightglow coating agent by the skin printer or the user client and for guiding output of an image;

FIGS. 30 and 31 illustrate that the skin printer outputs the inverted image on the nightglow coating agent applied to the body part, and the outputting of the nightglow image is completed;

FIG. 32 is a flowchart illustrating a method for performing a multipath output by a skin printer according to an embodiment;

FIG. 33 is a view illustrating that multipath output is performed by using a wearable device put on one position of a body part of a user;

FIG. 34 is a view illustrating that the position of the skin printer is calculated using a virtual axis;

FIG. 35 is a view illustrating that the position of the skin printer is calculated using a plurality of virtual axes;

FIG. 36 is a view illustrating that the angle of the skin printer is calculated using a plurality of sensor devices;

FIG. 37 is a view illustrating that a guide device to assist the skin printer is used;

FIG. 38 is a view illustrating a system for providing a marketing service using a skin printer, according to one embodiment;

FIG. 39 is a flowchart illustrating a method for providing a marketing service using a skin printer, according to an embodiment;

FIGS. 40 and 41 are views illustrating that the skin printer outputs an image to a body part of a customer; and

FIG. 42 is a view illustrating an open market service system for sharing and trading an image output from a skin printer, according to one embodiment.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Spatially relative terms, such as “below”, “beneath”, “lower”, “above”, “upper”, and the like, may be used herein to make it easier to describe the relationship between one component and another component. It will be understood that the spatially relative terms are intended to encompass different orientations of the component in use or operation in addition to the orientation depicted in the figures. For example, when a component illustrated in accompanying drawings is reversed, a component provided ‘below’ or ‘beneath’ another device may be placed ‘above’ another component. Accordingly, the term “below” may include both concepts of “below” and “above. A component may be oriented in a different direction. Accordingly, terminology having relatively spatial concepts may be variously interpreted depending on orientations.

Hereinafter, exemplary embodiments of the inventive concept will be described with reference to accompanying drawings.

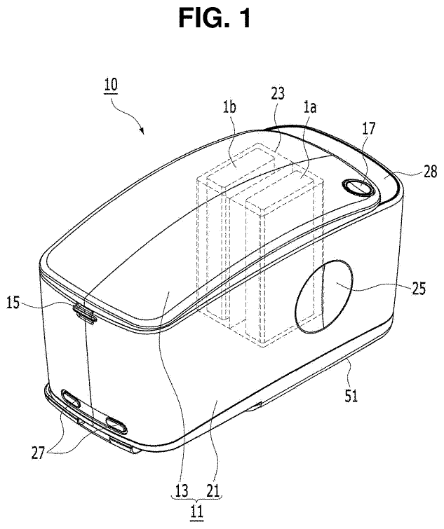

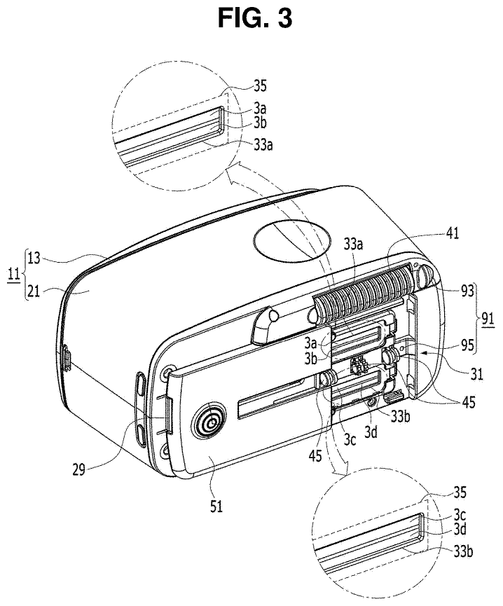

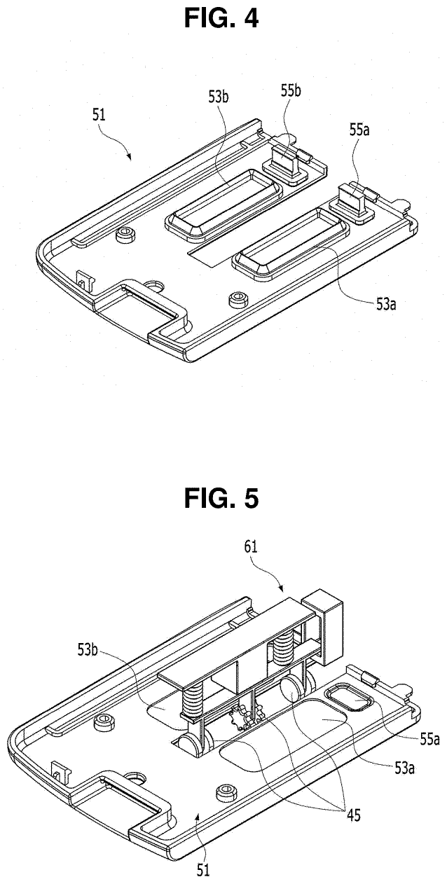

FIGS. 1 to 8 illustrate a skin printer, according to an embodiment of the inventive concept.

As illustrated in the drawings, according to an embodiment of the inventive concept, the skin printer 10 includes a printer housing 11, a main roller 41, and a plurality of spacing rollers 45.

The printer housing 11 forms the whole outer appearance of the skin printer 10 and has the shape of a box allowing a user to simply hold the printer housing 11 for use.

The printer housing 11 is formed by combining an upper printer housing 13 with a lower printer housing 21 such that cartridges 1a and 1b are easily replaced with new ones.

The lower printer housing 21 has the shape of a box having an open top surface, and the upper printer housing 13 is provided to cover the open top surface of the lower printer housing 21.

The upper printer housing 13 may be rotatably coupled, by a hinge 15, to one side of the lower printer housing 21 to open and close the top surface of the lower printer housing 21.

In this case, according to the inventive concept, although the upper printer housing 13 is hinge-coupled to the lower printer housing 21, the inventive concept is not limited thereto, but the upper printer housing 13 is detachably coupled to the lower printer housing 21. In other words, although not illustrated in the drawings, the upper printer housing 13 and the lower printer housing 21, which have an elastic coupling protrusion and a coupling groove, respectively, may be detachably coupled to each other as the elastic coupling protrusion is inserted into the coupling groove. Alternatively, the upper printer housing 13 and the lower printer housing 21 may be detachably coupled through a separate fastening member, such as a screw, a bolt, a pin, or a rivet.

The upper printer housing 13 includes an operating button 17 to operate the skin printer 10.

The lower printer housing 21 has a controller (not illustrated) received therein to control the operation of the skin printer 10. In addition, the lower printer housing 21 is formed therein with a receiving part 23 to receive a plurality of cartridges 1a and 1b. Meanwhile, the cartridges 1a and 1b received in the receiving part 23 contain printing solutions. The printing solutions contained in the cartridges 1a and 1b are discharged through nozzles 3a, 3b, 3c and 3d of the cartridges 1a and 1b.

The lower printer housing 21 is provided at opposite sides thereof with finger grip parts 25 to prevent fingers from slipping out of the printer housing 11 when the user grips the printer housing 11.

In addition, according to the inventive concept, the lower printer housing 21 includes a lamp 28 to display an operating state of the skin printer 10 and a button part 27 to turn on power and Bluetooth.

A printing head 31 is provided at one area of the bottom surface of the lower printer housing 21 to output an image. In this case, although illustrated in the drawings, the printing head 31 may be provided to protrude while forming a step difference from the bottom surface of the lower printer housing 21. As described above, the printing head 31 is formed with a step difference from the bottom surface of the lower printer housing 21, thereby preventing the bottom surface of the lower printer housing 21 from making contact with a skin other than a printing area to interrupt printing and to prevent a user to feel displeasure caused by the contact with the skin.

A pair of discharge holes 33a and 33b are formed in the printing head 31 while being spaced apart from each other to communicate with the receiving part 23. The discharge holes 33a and 33b are provided corresponding to the cartridges 1a and 1b. According to the present embodiment, the cartridges 1a and 1b are received in the receiving part 23. The discharge holes 33a and 33b are used to discharge the printing solutions from the relevant nozzles 3a, 3b, 3c and 3d of the relevant cartridges 1a and 1b.

In addition, gaskets serving as sealing members 35 are provided on the discharge holes 33a and 33b. The sealing members maintain the airtightness between the nozzles 3a, 3b, 3c and 3d of the cartridges 1a and 1b, and the discharge holes 33a and 33b. In this case, the sealing member 35 may include an O-ring instead of the gasket.

Hereinafter, a cartridge, which is adjacent to the main roller 41, of the pair of cartridges will be referred to as a “first cartridge 1a”, and a remaining cartridge will be referred to as a “second cartridge 1b”. In addition, a discharge hole, through which the nozzles 3a and 3b of the first cartridge 1a are exposed among the pair of discharge holes, will be referred to as a “first discharge hole 33a” and a discharge hole, through which the nozzles 3c and 3d of the second cartridge 1b are exposed, will be referred to as a “second discharge hole 33b”.

The following description will be made in that the printing solution contained in the cartridges 1a and 1b is an ink for printing an image on a skin. The ink may employ the composition of cyan (C), magenta (M), yellow (Y), and white (white) colors, instead of cyan (C), magenta (M), yellow (Y), and black (K) colors, but the inventive concept is not limited thereto.

According to the present embodiment, an ink (Y color ink) of Y color and an ink (W color ink) of W color are independently received in the first cartridge 1a, and the first nozzle 3a and the second nozzle 3b are spaced apart from each other to discharge the ink of the Y color and the ink of the W color, respectively. In addition, an ink (C color ink) of C color and an ink (M color ink) of M color are independently received in the second cartridge 1b, and the third nozzle 3c and the fourth nozzle 3d, which discharge the ink of the C color and ink of the M color, respectively, are spaced apart from each other.

In this case, one of the pair of cartridges 1a and 1b may independently contain the ink of the C color and the ink of the M color, and a remaining one of the cartridges 1a and 1b contains only the ink of the Y color. In addition, one cartridge may receive only inks of C, M, Y, and W colors.

In addition, the printing solution contained in the cartridges 1a and 1b may include any one of a coating agent for coating the skin, a fragrant material for generating fragrance, a fluorescent substance for nightglow output, instead of inks having different colors as described above, or the combination of at least one of an ink, a coating agent, a fragrant material, and a fluorescent substance.

In this case, according to the present embodiment, although it is illustrated that a pair of discharge holes 33a and 33b and a pair of cartridges 1a and 1b are provided, the number of discharge holes and cartridges are not limited thereto.

The main roller 41 has the shape of a roll having a specific length and is rollably provided ahead in a forward direction of the skin printer 10, for example, at one side of the printing head 31 of the printer housing 11. According to the present embodiment, the main roller 41 is provided in parallel with the discharge holes 33a and 33b, but is not limited thereto. For example, the main roller 41 may be provided in a shape like a ball or a wheel. The main roller 41 guides the printer housing 11 to move along the skin, when printing is performed with respect to the skin using the skin printer 10.

The plurality of spacing rollers 45 are interposed between the pair of discharge holes 33a and 33b, which are adjacent to each other, and are rollably provided in the printer housing 11. According to the present embodiment, although three spacing rollers 45 are provided while being spaced apart from each other by a specific distance, at least one spacing roller may be provided.

The plurality of spacing rollers 45 space the printer housing 11 from the skin and roll along the skin together with the main roller 41.

Each spacing roller 45 has the shape of a wheel to reduce the contact area with the skin. In particular, the rolling surface the spacing roller 45, which is disposed at the center between the pair of discharge holes 33a and 33b positioned on a printing path, that is, the rolling surface of the spacing roller 45 making contact with the skin has a roughness.

As described above, the spacing roller 45 is provided between the pair of discharge holes 33a and 33b of the printing head 31 of the printer housing 11, thereby preventing the ink, which is discharged through the first discharge hole 33a, from making contact with the printer housing 11 to be spread along the skin. In particular, the rolling surface the spacing roller 45, which is disposed at the center between the pair of discharge holes 33a and 33b positioned on a printing path, has the rolling surface, thereby firmly maintaining the distance between the printer housing 11 and the skin, minimizing the contact area with the ink discharged through the first discharge hole 33a such that an image similar to the original image is printed on the skin without an ink spread in printing.

In this case, all spacing rollers 45 and the main roller 41 may be treated through resist printing to minimize the stain the roller surface with the ink, thereby preventing the rollers from being stained with the ink discharged to the skin and transferred to the skin again. A cleaning unit may be provided at upper ends of the roller to remove the residual ink, thereby preventing the roller from being stained to be transferred to the skin again even though the roller is treated through the resist printing. The cleaning unit includes a specific material to absorb and to remove the ink remaining on the roller surface or may dry the ink through an air circulation manner using wind or heat to remove the ink, but the inventive concept is not limited thereto.

In addition, according to an embodiment of the inventive concept, the skin printer 10 further includes a cover 51.

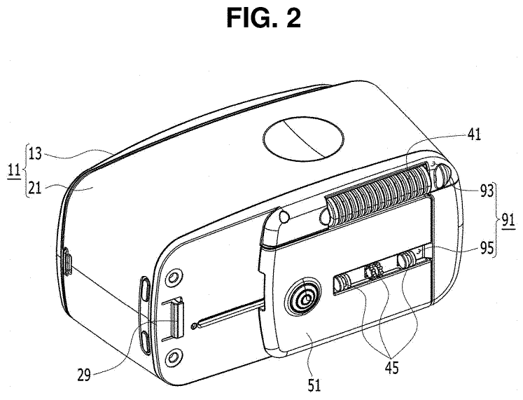

The cover 51 is slidably coupled to the lower portion of the lower printer housing 21, that is, to the printing head 31. The cover 51 reciprocates between a first position in which the discharge holes 33a and 33b are closed as illustrated in FIG. 2 and a second position in which the discharge holes 33a and 33b are open as illustrated in FIG. 2.

In addition, a pair of caps 53a and 53b are provided on the bottom surface of the cover 51 facing the lower portion of the lower printer housing 21.

The pair of caps 53a and 53b are provided on the cover 51 to correspond to the pair of discharge holes 33a and 33b, respectively. The pair of caps 53a and 53b open or close the pair of discharge holes 33a and 33b as the cover 51 reciprocates.

The caps 53a and 53b serve as covers at the first position to prevent the discharge holes 33a and 33b from being exposed to the outside while making contact with the nozzles 3a, 3b, 3c, and 3d of the cartridges 1a and 1b. The caps 53a and 53b are formed to make close contact with the circumference of the nozzles 3a, 3b, 3c, and 3d of the cartridges 1a and 1b, and are recessed at the centers thereof. Thus, when the caps 53a and 53b are in the first position, the caps 53a and 53b make contact with the circumference of the nozzles 3a, 3b, 3c and 3d of the cartridges 1a and 1b, and inks dripping from the nozzles 3a, 3b, 3c, and 3d are collected at the central region of 53b to prevent contamination of the ink.

In addition, a pair of caps 55a and 55b are provided on the bottom surface of the cover 51 facing the lower portion of the lower printer housing 21.

A pair of wiping parts 55a and 55b are provided on the cover 51 to correspond to the pair of discharge holes 33a and 33b, respectively. The pair of wiping parts 55a and 55b make contact with the nozzles 3a, 3b, 3c and 3d of the cartridges 1a and 1b exposed through the discharge holes 33a and 33b while cleaning the nozzles 3a, 3b, 3c and 3d of the cartridges 1a and 1b by removing the ink from the nozzles 3a, 3b, 3c and 3d of the cartridges 1a and 1b, when the cover 51 is moved from the first position to the second position. The wiping parts 55a and 55b may include a porous absorbent material, such as a fiber or a sponge, which is able to absorb the ink.

Meanwhile, when the cover 51 moves from the first position to the second position, the movement of the cover 51 is limited by a stopper 29 provided at the lower portion of the lower printer housing 21.

As described above, the caps 53a and 53b and the wiping parts 55a and 55b are provided in the cover 51, thereby preventing the residual ink of the nozzles 3a, 3b, 3c and 3d of the cartridges 1a and 1b from interrupting the discharge of the ink to form a droplet or preventing the nozzles 3a, 3b, 3c and 3d from being clogged. Accordingly, the nozzles 3a, 3b, 3c, and 3d of the cartridges 1a and 1b may be maintained in the optimal state to maintain the printing quality.

In this case, the wiping parts 55a and 55b may have upper ends formed in the shape of a hook to efficiently remove the residual ink on the surfaces of the cartridges 1a and 1b. Accordingly, upper portions of the wiping parts 55a and 55b make close contact with the surfaces of the cartridges 1a and 1b, such that the remaining foreign matters are more easily removed.

In addition, according to an embodiment of the inventive concept, the skin printer 10 further includes a roller lifter 61.

The roller lifter 61 elevates the spacing roller 45 and the pair of cartridges 1a and 1b from the printer housing 11 along the curvature of the skin for printing.

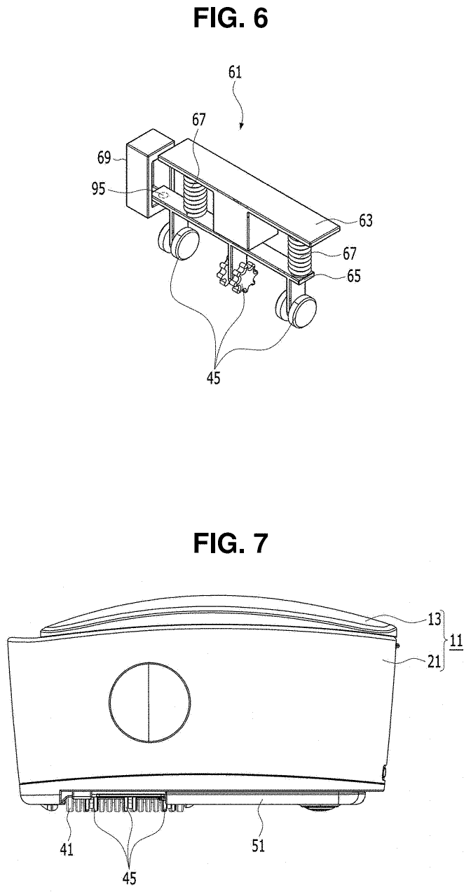

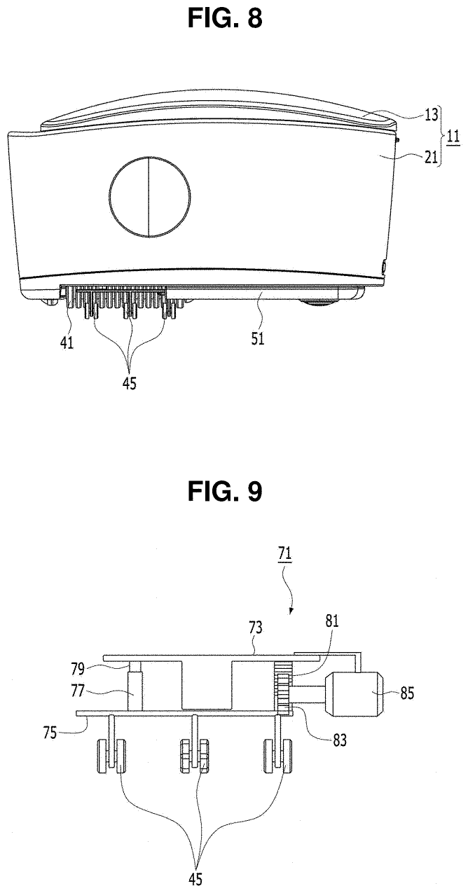

As illustrated in FIGS. 5 and 6, the roller lifter 61 includes a bracket 63, a roller support 65, and an elastic member 67.

The bracket 63 is received in the receiving part 23 while partitioning the receiving part 23 of the lower printer housing 21 and supported inside the lower printer housing 21. One side of the bracket 63 has the shape of partially protruding toward the roller support 65. Accordingly, the bracket 63 may maintain the minimum distance from the roller support 65 when the roller support 65 is lifted.

The roller support 65 is positioned under the bracket 63 and the plurality of spacing rollers 45 are rollably provided at the lower portion of the roller support 65. The roller support 65 lifts in relation to the bracket 63.

The elastic member 67 elastically supports the roller support 65 and the bracket 63 while linking the roller support 65 and the bracket 63 to each other. According to the present embodiment, a pair of elastic members 67 are disposed with a specific distance. Although the elastic member 67 includes a coil spring according to the present embodiment, the inventive concept is not limited thereto. The elastic member 67 may include a conical spring and a leaf spring.

The elastic member 67 provides an elastic force to the roller support 65 and the bracket 63 such that the roller support 65 and the bracket 63 maintain a specific distance therebetween. In other words, the elastic member 67 maintains the distance between the skin and the nozzles 3a, 3b, 3c, and 3d by lifting the spacing rollers 45 along the curvature of the skin.

In addition, the skin printer 10 according to an embodiment of the inventive concept may further include a curvature sensing unit 91 and a lifting actuator 69.

The curvature sensing unit 91 is provided at one area of the printer housing 11 to sense the curvature of the printed skin. The curvature sensing unit 91 includes a first distance sensor 93 disposed in the lower printer housing 21 to be adjacent to the main roller 41 to measure the distance from the skin, and a second distance sensor 95 disposed at one side of the roller support 65 to measure the distance from the skin.

Accordingly, the curvature of the skin may be estimated based on the distances measured by the first distance sensor 93 and the second distance sensor 95.

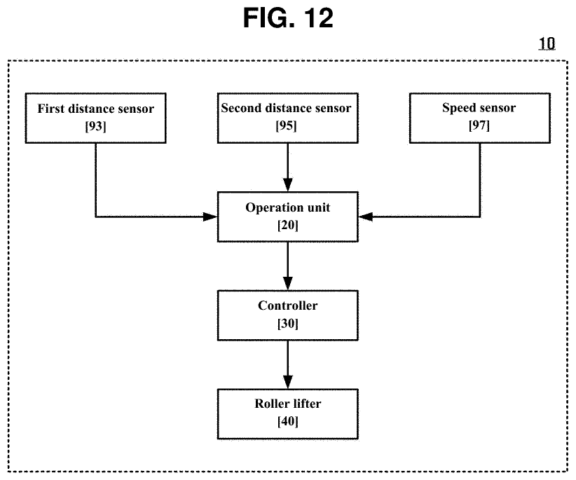

For example, when d1 is smaller than d2, the skin printer 10 may recognize that a curved surface exists, and estimate or calculate the curvature of the curved surface based on the difference between d1 and d2, as illustrated in FIG. 11.

In this case, the distance sensors 93 and 95 may include an infrared sensor or a near field ultrasonic sensor, or a depth camera may be used to measure the distance.

The lifting actuator 69, which is a component of the roller lifter 61, lifts the roller support 65 in response to a curvature data signal of the skin, which is measured from the curvature sensing unit 91. The lifting actuator 69 may include a linear motor to straightly reciprocate.

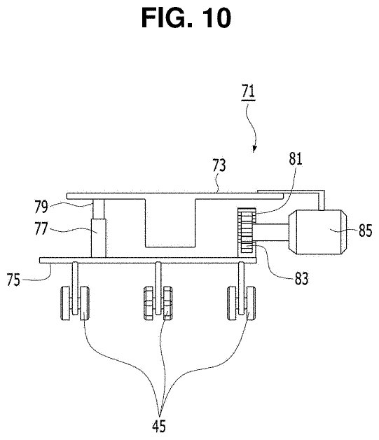

Through such a component, when printing is performed with respect to the flat surface of the skin, the front end portion of the spacing roller 45 has the height equal to the height of the front end portion of the main roller 41 to maintain the distance between the skin and the nozzles 3a, 3b, 3c, and 3d of the cartridges 1a an 1b such that the image is printed on the skin as illustrated in FIG. 7. Meanwhile, when the curved portion of the skin, for example, an area, which has a larger curvature, of the skin is printed, the nozzles 3a, 3b, 3c, and 3d of the cartridges 1a and 1b make contact with the curved portion of the skin. Accordingly, as illustrated in FIG. 8, the lifting actuator 69 operates such that the spacing roller 45 moves down toward the skin, that is, the spacing roller 45 is spaced apart from the lower printer housing 21. Accordingly, the skin maintains the distance from the nozzles 3a, 3b, 3c, and 3d of the cartridges 1a and 1b without the contact therebetween while the printing is performed with respect to the skin.

As described above, the curvature sensing unit 91 and the lifting actuator 69 are provided to move up and down the spacing roller 45 based on the curvature estimated or calculated by the curvature sensing unit 91, for example, to move up and down the spacing roller 45 along the curvature of the skin, thereby automatically uniformly adjusting the distances between the skin and the nozzles 3a, 3b, 3c, and 3d of the cartridges 1a and 1b, such that printing is stably performed with respect to the skin.

Meanwhile, the roller lifter may be manually operated without the curvature sensing unit 91 and the lifting actuator 69.

When the flat portion of the skin is printed using the skin printer including the roller lifter, a force to be applied to the spacing roller 45 may be adjusted to maintain the distance between the skin and the nozzles 3a, 3b, 3c, and 3d of the cartridges 1a and 1b while making the front end portion of the spacing roller 45 having the height equal to the height of the front end portion of the main roller to perform printing on the skin. Meanwhile, when a curved portion of the skin is printed, a force to be applied to the spacing roller 45 is adjusted to allow the spacing roller 45 to move down toward the skin, that is, allow the spacing roller 45 to be spaced apart from the lower printer housing 21, thereby preventing the nozzles 3a, 3b, 3c, and 3d of the cartridges 1a and 1b from making contact with the curved portion of the skin to perform printing on the skin.

In other words, a user may grip the skin printer 10 and adjusts a force applied to the spacing roller 45 along the curvature of the skin while moving up and down the spacing roller 45 and manually adjusts the distance between the skin and the nozzles 3a, 3b, 3c, and 3d of the cartridges 1a and 1b to be uniform, thereby perform the printing with respect to the skin.

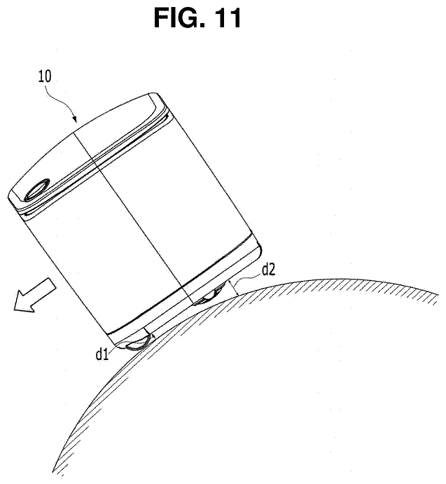

FIGS. 9 and 10 illustrate another embodiment of the roller lifter.

According to another embodiment, the roller lifter 71 includes a bracket 73, a roller support 75, a rack 81, a pinion 83, and a lifting actuator 85.

The bracket 73 is received in the receiving part 23 while partitioning the receiving part 23 of the lower printer housing 21 and supported inside the lower printer housing 21. One side of the bracket 73 has the shape of partially protruding toward the roller support 75. Accordingly, the bracket 73 may maintain the minimum distance from the roller support 75 when the roller support 75 is lifted.

The roller support 75 is positioned under the bracket 73 and the plurality of spacing rollers 45 are rollably provided at the lower portion of the roller support 75. The roller support 75 lifts in relation to the bracket 73.

The roller support 75 and the bracket 73 are linked to each other by a guide rod 77 provided on the roller support 75 and a guide rod 79 provided on the bracket 73. When the roller support 75 lifts with respect to the bracket 73, the guide rod 77 and the guide rod 79 also serve to guide the lifting of the roller support 75.

A rack 8 is supported to the bracket 73 to stand erectly on the bracket 73 in the direction of lifting the roller support 75, and a plurality of teeth are formed on one side of the rack 81.

The pinion 83 has the form of an external tooth and rotates in engagement with the teeth of the rack 81.

The lifting actuator 85, which is a component of the roller lifter 71, lifts the roller support 75 by reversibly rotating the pinion 83 in response to a curvature data signal of the skin, which is measured from the curvature sensing unit 91. For example, the lifting actuator 85 rotates the pinion 83 forward to move down the rack 81 while moving down the roller support 75, or rotates the pinion rearward to move up the rack 81 while moving up the roller support 75. A typical motor is provided as the lifting actuator 85, and supported by the bracket 73.

As described above, the roller lifter 71 including the rack 81, the pinion 83, the lifting actuator 85 and the curvature sensing unit 91, which senses the curvature of the skin for printing, are provided, thereby reversibly rotating the pinion 83, lifting the rack 81, and lifting the spacing roller 45 and the pair of cartridges 1a and 1b, based on the curvature estimated or calculated by the curvature sensing unit 91.

FIG. 9 illustrates the state of the spacing roller 45 when printing is performed on the flat area of the skin using the skin printer 10, and FIG. 10 illustrates the state of the spacing roller 45 when printing is performed on the curved portion of the skin using the skin printer 10. As illustrated in FIG. 10, when the printing is performed with respect to the curved portion of the skin, the spacing roller 45 is moved down further apart from the lower printer housing 21 as compared to when printing is performed with respect to the flat area of the skin.

Accordingly, the roller support 75 is lifted while the spacing roller 45 is lifted, through the rack 81 and the pinion 83 of the roller lifter 71 along the curvature of the skin for printing to automatically adjust the distances between the skin and the nozzles 3a, 3b, 3c, and 3d of the cartridges 1a and 1b to be uniform, thereby preventing an image, which is printed, from being defected as the nozzles 3a, 3b, 3c, and 3d of the cartridges 1a and 1b make contact with the skin because the distances between the skin and the nozzles 3a, 3b, 3c, and 3d of the cartridges 1a and 1b are reduced due to the curvature of the skin. In addition, when the distances between the skin and the nozzles 3a, 3b, 3c, and 3d of the cartridges 1a and 1b are increased, the ink is prevented from being scattered and the dot size is prevented from being increased, thereby preventing the printing quality from being degraded such that the printing may be stably performed.

Although the previous embodiment has been described in that the spacing roller 45 is moved up and down by the roller lifters 61 and 71 along the curvature of the skin, the inventive concept is not limited. Although not illustrated in the drawing, the main roller 41 may be moved up and down in the similar manner to the spacing roller 45.

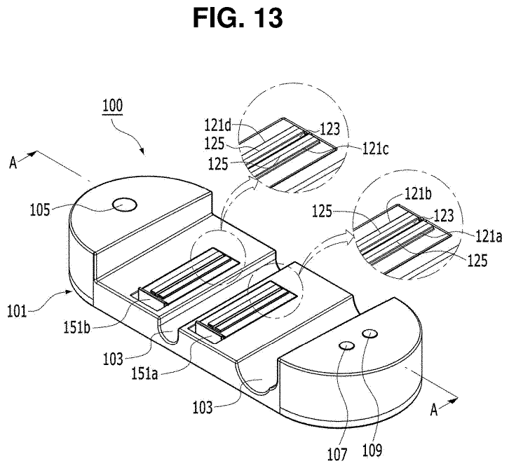

FIG. 12 is a view illustrating the configuration of the skin printer illustrating a method for controlling the roller to be moved up and down, according to an embodiment of the inventive concept.

Referring to FIG. 12, the skin printer 10 includes a first distance sensor 93, a second distance sensor 95, a speed sensor 97, an operation unit 20, a controller 30, and a roller lifter 40.

The skin printer 10 includes the operation unit 20 that calculates information necessary for moving up and down the main roller and the spacing roller using data obtained from the first distance sensor 93, the second distance sensor 95, and the speed sensor 97. The data calculated by the operating unit 20 is used by the controller 30 to control the roller lifter 40.

According to an embodiment, the roller lifter 40 corresponds to at least one of the roller lifter 61 and 71 illustrated in FIGS. 5 and 9, respectively. The roller lifter 40 includes the lifting actuators 69 and 85 including at least one motor.

The operation unit 20 receives distance data measured by the first distance sensor 93 and the second distance sensor 95. When the distance measured by the first distance sensor 93 is d1 and the distance measured by the second distance sensor 95 is d2, the operation unit 20 calculates a slop ‘g1’ and the angle ‘a’ of the slop as in following Equation.

g1=d1−d2

a=a tan(g1/g2)

In the above Equation, ‘g2’ is a distance between two distance sensors which are previously designed.

According to an embodiment, the operation unit 20 measures the speed in the forward direction of the skin printer 10 through the speed sensor 97. For example, the speed sensor 97 is linked to the shaft of the main roller 41 to measure the number of revolutions or revolutions per minute (RPM) of the main roller 41. The operation unit 20 calculates the speed of the skin printer 10 based on the number of revolutions or revolutions per minute (RPM) of the main roller 41.

The controller 30 controls the roller lifter 40 based on the operation result of the operation unit 20.

For example, the following description will be made on the assumption that the slope “a” of the skin printer is 10° and the moving speed of the skin printer 10 is 50 mm/s

On the assumption that the skin printer 10 needs to be moved down by the distance of 10 mm when the slope is 10°, there may be applied a method for controlling the linear motor included in the roller lifter 40 to rotate in the forward direction at the speed of 10 rpm for one second or at the speed of 100 rpm for 0.1 second.

In this case, when the moving speed of the skin printer 10 is fast, the RPM of the motor is increased, and the control time is reduced such that the spacing roller 45 is rapidly moved up. When the moving sped of the skin printer 10 is slow, the RPM of the motor is decreased and the control time is increased such that the spacing roller is slowly moved up.

When the spacing roller is rapidly moved up while the skin printer 10 is slowly moved, the gap between the skin and the nozzles are instantaneously increased, so the ink may be scattered. Therefore, the controller 30 adjusts the moving-up speed of the spacing roller to be matched the moving speed of the skin printer 10.

Following table 1 illustrates a method for controlling the motor depending on the speed and the angle of the skin printer 10.

TABLE 1

| Speed | Slope | Motor control condition |
|---|---|---|
| 10 mm/s | 10° | 10 rpm, 0.5 seconds |
| | 20° | 20 rpm, 0.5 seconds |
| 20 mm/s | 10° | 20 rpm, 0.2 seconds |
| | 20° | 30 rpm, 0.2 seconds |

The above table is to explain a method for differently setting a motor control condition depending on the speed and the angle of the skin printer 10. Actually, a method for controlling, by the controller 30, the motor control condition depending on the speed and the angle of the skin printer 10 and the detailed numeric values in the method are not limited to the above-described table.

Meanwhile, although the previous embodiment has been described in that the skin printer 10 according to the inventive concept is limited to printing an image on a skin, a printing medium is not limited to the skin. In other words, according to the inventive concept, the skin printer 10 may be applied to a print medium such as fabric or paper.

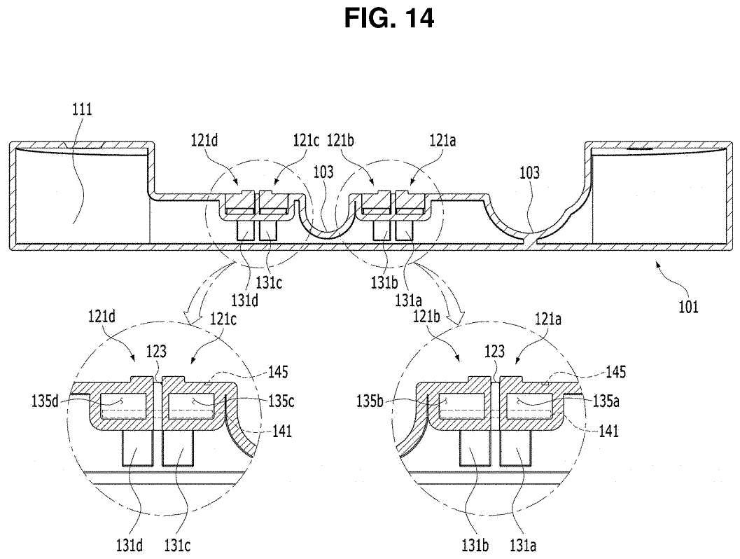

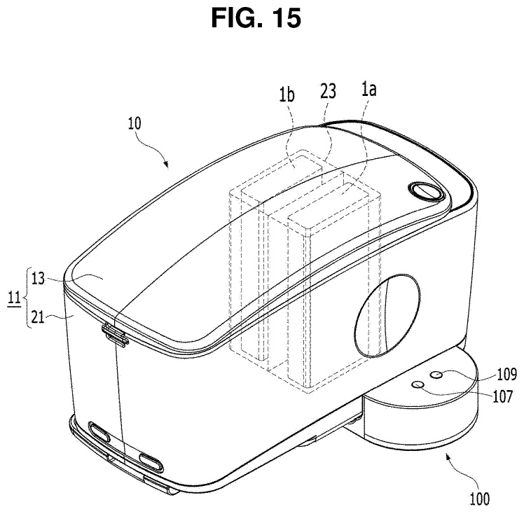

FIGS. 13 to 14 illustrate a skin printer, according to an embodiment of the inventive concept.

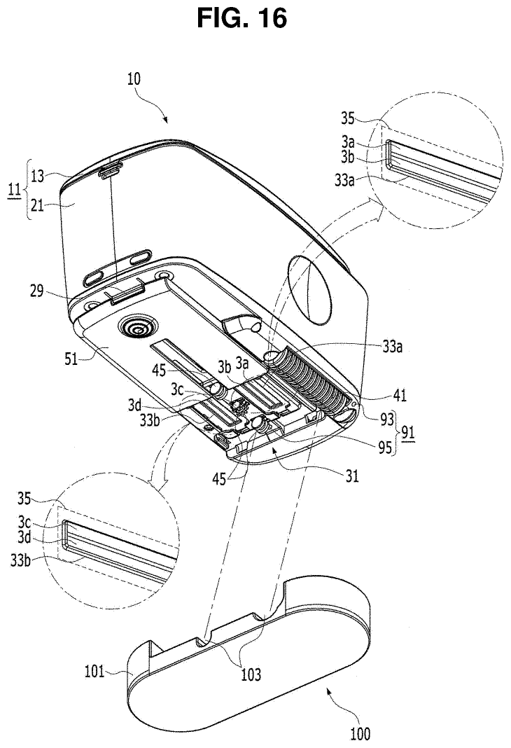

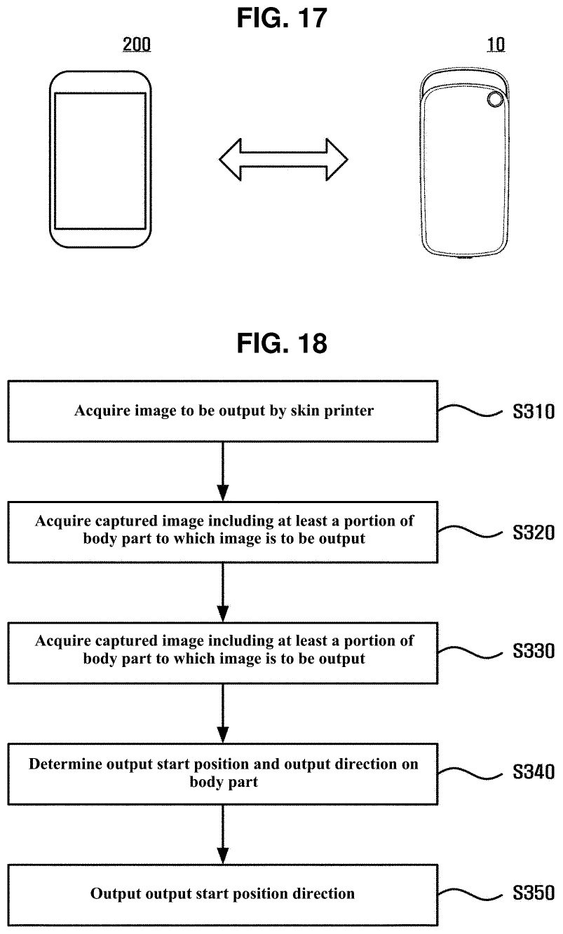

Hereinafter, the skin printer 10 to be mounted on a docking station 100 for a skin printer will be described in brief with reference to FIGS. 15 and 16 before describing the docking station 100 for the skin printer in detail according to an embodiment of the inventive concept.

The skin printer 10 includes a printer housing 11, a main roller 41, and a plurality of spacing rollers 45.

The printer housing 11 forms the whole outer appearance of the skin printer 10 and has the shape of a box allowing a user to simply hold the printer housing 11 for use.

The printer housing 11 is formed by combining an upper printer housing 13 with a lower printer housing 21 such that cartridges 1a and 1b are easily replaced with new ones.

A printing head 31 is provided at one area of the bottom surface of the lower printer housing 21 to output an image.

A receiving part 23 is provided in the printer housing 11 to receive a pair of cartridges 1a and 1b containing inks of mutually different colors.

A pair of discharge holes 33a and 33b are formed in the printing head 31 while being spaced apart from each other to communicate with the receiving part 23. The discharge holes 33a and 33b are provided in the pair of cartridges 1a and 1b, respectively. The discharge holes 33a and 33b are used to discharge the ink of mutually different colors from the relevant nozzles 3a, 3b, 3c and 3d of the relevant cartridges 1a and 1b

Hereinafter, a cartridge, which is adjacent to the main roller 41, of the pair of cartridges will be referred to as a “first cartridge 1a”, and a remaining cartridge will be referred to as a “second cartridge 1b”. In addition, a discharge hole, through which the nozzles 3a and 3b of the first cartridge 1a are exposed among the pair of discharge holes, will be referred to as a “first discharge hole 33a” and a discharge hole, through which the nozzles 3c and 3d of the second cartridge 1b are exposed, will be referred to as a “second discharge hole 33b”.

According to the present embodiment an ink of yellow (Y) color and an ink of white (W) color are independently received in the first cartridge 1a, and the first nozzle 3a and the second nozzle 3b are spaced apart from each other to discharge the ink of the Y color and ink of the W color, respectively. In addition, an ink of cyan (C) color and an ink of magenta (M) color are independently received in the second cartridge 1b, and the third nozzle 3c and the fourth nozzle 3d, which discharge the ink of the C color and an ink of the M color, respectively, are spaced apart from each other.

According to an embodiment, the first cartridge 1a and the second cartridge 1b contain inks of only C, M, and Y, and K colors may output by mixing C, M, and Y colors.

Preferably, since the Y color ink is similar to the skin color or is inconspicuous, even if the spacing roller 45 passes on the Y color ink output on the skin, the image may be less damaged. Therefore, the Y color ink may be output from the first nozzle 3a or the second nozzle 3b, and the C and M color inks may be output from the third nozzle 3c or the fourth nozzle 3d, respectively, the inventive concept is not limited thereto.

According to an embodiment, the Y color ink is discharged from the first nozzle 3a or the second nozzle 3b, and a C or M color ink is discharged from the third nozzle 3c or the fourth nozzle 3d. On the assumption that the Y color ink is discharged from the second nozzle 3b, the cartridge corresponding to the first nozzle 3a may be empty.

In addition, the cartridge corresponding to the first nozzle 3a may contain a material for assisting skin printing. In addition, a cartridge corresponding to the first nozzle 3a may contain a coating agent for coating the skin before outputting ink to the skin, a fragrant material for generating fragrance, or a fluorescent substance for nightglow output, but the type of the coating agent, the fragrant material or the fluorescent substance is not limited.

The coating agent for coating the skin before outputting ink to the skin, the fragrant material for generating fragrance, or the fluorescent substance for nightglow output are contained in the cartridge of the skin printer, but separately received in a spray device. Accordingly, a user may directly apply the coating agent, the fragrant material, or the fluorescent substance to the skin and perform printing for the applied skin portion through the skin printer.

According to an embodiment, the coating agent to be applied onto the printout printed on the skin may be contained in the cartridge corresponding to the fourth nozzle 1d. In addition, the coating agent may be received in the separate spray device, such that the user personally applies the coating agent to the printout of the skin.

Similarly, the above-mentioned spray device is provided in at least one of a front portion or back portion of the skin printer in the forward direction of the skin printer, such that the skin printer may apply a material necessary for skin printing (for example, coating agent or fluorescent substance) to the skin automatically or under user control.

The main roller 41 has the shape of a roll having a specific length, and is rollably provided in a front portion of the skin printer 10 in the forward direction of the skin printer 10, that is, provided at one side of the printing head 31 of the printer housing 11. The main roller 41 guides the printer housing 11 to move along the skin, when printing is performed with respect to the skin using the skin printer 10.

The plurality of spacing rollers 45 are interposed between the pair of discharge holes 33a and 33b, which are adjacent to each other, and are rollably provided in the printer housing 11. The plurality of spacing rollers 45 space the printer housing 11 from the skin and roll along the skin together with the main roller 41.

As described above, the spacing roller 45 is provided between the pair of discharge holes 33a and 33b of the printing head 31 of the printer housing 11, thereby preventing the ink, which is discharged through the first discharge hole 33a, from making contact with the printer housing 11 to be spread along the skin.

In addition, the skin printer 10 further includes a cover 51

The cover 51 is slidably coupled to the lower portion of the lower printer housing 21, that is, to the printing head 31. The cover 51 reciprocates between a first position in which the discharge holes 33a and 33b are closed and a second position in which the discharge holes 33a and 33b are open.

Meanwhile, when the cover 51 moves from the first position to the second position, the movement of the cover 51 is limited by a stopper 29 provided at the lower portion of the lower printer housing 21.

Accordingly, when the printing head 31 of the skin printer 10 is arranged toward the skin of the user, and the main roller 41 and the spacing roller 45 are rolled along the skin for printing, in the state that the cover 51 is moved to the second position, inks having mutually different colors are discharged from the first nozzle 3a and the second nozzle 3b of the first cartridge 1a, and then inks having mutually different colors are discharged from the third nozzle 3c and the fourth nozzle 3d of the second cartridge 1b along the printing path, such that a desired image is printed on the skin.

Returning to the main point, according to an embodiment of the inventive concept, the docking station 100 for a skin printer includes a docking station housing 101, a liquid tank 111, and a plurality of nozzle caps 121a, 121b, 121c, and 121d, and a plurality of absorbing members 131a, 131b, 131c, and 131d.

The docking station housing 101 has a hollow barrel shape. The docking station housing 101 is mounted with the skin printer 10 described above.

A pair of roller receiving grooves 103 are recessed at the upper portion of the docking station housing 101 to receive the main roller 41 and the plurality of spacing rollers 45 of the skin printer 10, respectively.

The liquid tank 111 is provided on one side of an inner part the docking station housing 101 to receive a liquid. The liquid tank 111 is injected with liquid through a liquid inlet 105 provided in one side of the upper portion of the docking station housing 101. In addition, a remaining amount of liquid contained in the liquid tank 111 is displayed through a remaining liquid level warning lamp 107 provided at an opposite side of the upper portion of the docking station housing 101. When the amount of liquid contained in the liquid tank 111 is equal to or less than a specific reference value, the remaining liquid level warning lamp 107 emits light.

The liquid tank 111 contains a liquid having the same or similar component as that of the ink contained in the skin printer 10. For example, the liquid tank 111 may receive a colorless solvent in which a color component is removed from the ink contained in the skin printer 10. In other words, according to an embodiment, the liquid may be any one of the inks of the cartridges 1a and 1b or a colorless solvent from which the color is removed.

A plurality of nozzle caps 121a, 121b, 121c, and 121d are provided in the docking station housing 101. The plurality of nozzle caps 121a, 121b, 121c, and 121d are provided at positions corresponding to the nozzles 3a, 3b, 3c, and 3d of the pair of cartridges 1a and 1b of the skin printer 10, respectively, to make contact with the nozzles 3a, 3b, 3c, and 3d of the pair of cartridges 1a and 1b. The nozzle cap 121a, 121b, 121c, and 121d have rectangular cross-sectional shapes corresponding to the shapes of the nozzles 3a, 3b, 3c and 3d of the pair of cartridges 1a, 1b.

Hereinafter, for convenience of description, the nozzle caps corresponding to the first nozzle 3a and the second nozzle 3b of the first cartridge 1a will be referred to as the first nozzle cap 121a and the second nozzle cap 121b, and the nozzle caps corresponding to the third nozzle 3c and the fourth nozzle 3d of the second cartridge 2a will be referred to as a third nozzle cap 121c and a fourth nozzle cap 121d, respectively.

The first nozzle cap 121a and the second nozzle cap 121b adjacent to each other are spaced apart from each other by a spacing groove 123. In addition, the third nozzle cap 121c and the fourth nozzle cap 121d adjacent to each other are spaced apart from each other by a spacing groove 123. As the first cartridge 1a and the second cartridge 1b are spaced apart from each other, the second nozzle cap 121b and the third nozzle cap 121c are spaced apart from each other.

As described above, as the nozzle caps 121a, 121b, 121c, and 121d are spaced apart from each other, the inks of different colors may be prevented from being mixed with each other.

Meanwhile, a liquid discharge part 125 is provided in each nozzle cap 121a, 121b, 121c, and 121d. The liquid discharge part 125 is finely cut in the form of a slit such that a capillary phenomenon works. The liquid discharge part 125 discharges a liquid provided from the liquid tank 111 toward each of the nozzle 3a, 3b, 3c and 3d of the cartridge 1a and 1b through the action of the capillary phenomenon.

In addition, although not illustrated in each nozzle cap 121a, 121b, 121c, and 121d, fine holes, grooves or roughness may be formed. Inks leaking from the nozzles 3a, 3b, 3c, and 3d of the cartridges 1a, 1b making contact with the nozzle caps 121a, 121b, 121c, and 121d through such fine holes, grooves, or roughness, for example, inks remaining in the nozzles 3a, 3b, 3c, and 3d are permeated into the nozzle caps 121a, 121b, 121c, and 121d through the action of the capillary phenomenon, and then collected inside the nozzle caps 121a, 121b, 121c, and 121d, for example, chamber 135a, 135b, 135c, and 135d to be described later. Accordingly, the inks remaining in the nozzles 3a, 3b, 3c, and 3d of the cartridges 1a and 1b of the skin printer 10 prevent a droplet, which is formed as the ink is prevented from being discharged, and prevents the nozzles 3a, 3b, 3c, and 3d from being clogged.

A plurality of absorbing members 131a, 131b, 131c, and 131d are provided in the plurality of nozzle caps 121a, 121b, 121c, and 121d, respectively. Similarly to the nozzle caps 121a, 121b, 121c, and 121d, the plurality of absorbing members 131a, 131b, 131c, and 131d are also spaced apart from each other to prevent inks having mutual different colors from being mixed with each other.

The absorbing members 131a, 131b, 131c, and 131d absorb the liquid in the liquid tank 111, and provide the liquid to the liquid discharge parts 125 of the nozzle cap 121a, 121b, 121c, and 121d. In other words, the liquid in the liquid tank 111 absorbed by the absorbing members 131a, 131b, 131c, and 131d is collected in the chambers 135a, 135b, 135c, and 135d, discharged to the liquid discharge part 125, and then provided to the nozzles 3a, 3b, 3c, and 3d of the cartridges 1a, and 1b in contact with the nozzle caps 121a, 121b, 121c, and 121d.

In this case, the absorbing members 131a, 131b, 131c, and 131d may include a porous absorbent material such as a fiber or a sponge that is able to absorb the liquid, but the inventive concept is not limited thereto.

In addition, according to an embodiment of the inventive concept, the nozzle cap 121a, 121b, 121c, and 121d of the docking station 100 for the skin printer include the chambers 135a, 135b, 135c, and 135d.

The chambers 135a, 135b, 135c, and 135d are provided at lower portions of the nozzle caps 121a, 121b, 121c, and 121d to communicate with the liquid discharge parts 125 of the nozzle caps 121a, 121b, 121c, and 121d.

The inks leaking from the nozzle 3a, 3b, 3c, and 3d of the cartridge 1a and 1b making contact with the nozzle cap 121a, 121b, 121c, and 121d are collected in the chamber 135a, 135b, 135c, and 135d via the nozzle caps 121a, 121b, 121c, and 121d by the action of the capillary phenomenon through fine holes, grooves, or roughness. In addition, the liquid in the liquid tank 111, which is absorbed by the absorbing members 131a, 131b, 131c, and 131d, is collected in the chambers 135a, 135b, 135c, and 135d. Meanwhile, the mixed solution of ink and liquid collected in the chambers 135a, 135b, 135c, and 135d is discharged to the liquid discharge part 125 by the action of the capillary phenomenon and provided to the nozzles 3a, 3b, 3c, and 3d of the cartridges 1a and 1b, which make contact with the nozzle caps 121a, 121b, 121c, 121d.

In addition, according to an embodiment of the inventive concept, the docking station 100 for a skin printer further includes a pressure sensor 141.

A pressure sensor 141 is provided in the docking station housing 101 to measure the pressure applied to the nozzle cap 121a, 121b, 121c, and 121d. In other words, the pressure sensor 141 is positioned under the nozzle caps 121a, 121b, 121c, and 121d, and it may be determined whether the skin printer 10 and the docking station 100 are docked, and whether the skin printer 10 is correctly docked to the docking station 100 based on the pressure data measured by the pressure sensor 141. The pressure data measured by the pressure sensor 141 may be displayed through a pressure indicator lamp 109 provided on an opposite side of the upper portion the docking station housing 101. In other words, when the pressure data measured by the pressure sensor 141 is equal to or less than the reference pressure value, the light is emitted through the pressure indicator lamp 109 such that the skin printer 10 are not correctly docked to the docking station 100.

In addition, according to an embodiment of the inventive concept, the docking station 100 for the skin printer further includes a humidity sensor 145.

The humidity sensor 145 is provided in the docking station housing 101 to measure the humidity around the nozzle cap 121a, 121b, 121c, and 121d. The humidity sensor 145 may be disposed around the nozzle caps 121a, 121b, 121c, and 121d, but may be disposed only around the first nozzle cap 121a and the third nozzle caps 121c and 121d as in the present embodiment.

It is determined whether each of the nozzle 3a, 3b, 3c, and 3d of the pair of cartridges 1a and 1b of the skin printer 10 is a docking station is exactly positioned in each of the nozzle caps 121a, 121b, 121c, and 121d of the docking station 100 and may be determined whether each of the nozzle caps 121a, 121b, 121c, and 121d is maintained in the optimal state, based on the humidity data measured by the humidity sensor 145. For example, when the humidity data measured by the humidity sensor 145 is less than the reference humidity value, light is emitted through a controller or a humidity indicator lamp, which is not illustrated, to notify to the outside of that the skin printer 10 and the docking station 100 are not docked exactly, and each of the nozzle caps 121a, 121b, 121c, and 121d is not maintained in the optimal state.

According to an embodiment of the inventive concept, the docking station 100 for a skin printer further includes nozzle cleaning units 151a and 151b.

According to the present embodiment, the nozzle cleaning units 151a and are provided in pairs corresponding to the number of the cartridges 1a and 1b. The nozzle cleaning units 151a and 151b are provided in the docking station housing 101 while being spaced apart from each other, in the longitudinal direction of the nozzle caps 121a, 121b, 121c and 121d. The nozzle cleaning units 151a and 151b wipe and clean the ink on the nozzles 3a, 3b, 3c and 3d of the cartridges 1a and 1b, which make contact with the nozzle caps 121a, 121b, 121c and 121d. The ink cleaned through the nozzle cleaning units 151a and 151b is dropped and collected into chambers 135a, 135b, 135c and 135d of the nozzle caps 121a, 121b, 121c and 121d, respectively. The nozzle cleaning units 151a and 151b may include a porous absorbent material such as a fiber or a sponge that can absorb ink, but the inventive concept is not limited thereto.

Through such a configuration, as illustrated in FIG. 16, in the state that the cover 51 of the skin printer 10 is moved to the second position, the skin printer 10 is mounted in the docking state 100 according to an embodiment as illustrated in FIG. 15.

In this case, the liquid stored in the liquid tank 111 of the docking station 100 is provided to the nozzle caps 121a, 121b, 121c, and 121d of the docking station 100 through the absorbing members 131a, 131b, 131c, and 131d, and a smaller amount of ink leaks from each of the nozzles 3a, 3b, 3c, and 3d of the cartridges 1a and 1b of the skin printer 10. Accordingly, the nozzles 3a, 3b, 3c, and 3d of the cartridges 1a and 1b of the skin printer 10 is maintained to be moisturized without being dried, so the nozzles 3a, 3b, 3c, and 3d of the cartridges 1a and 1b are maintained in the optimal state, thereby maintaining the printing quality.

In addition, according to an embodiment of the inventive concept, the docking station 100 may prevent residual ink of the nozzles 3a, 3b, 3c and 3d of the cartridges 1a and 1b from interrupting the discharge of the ink to form a droplet and may prevent the nozzles 3a, 3b, 3c and 3d from being clogged.

In addition, the docking station 100 according to an embodiment of the inventive concept includes at least one battery module. The docking station 100 receives power from an external power source and stores the power in the battery module. In addition, the docking station 100, which includes at least one wired charging terminal or a wireless charging module, is connected to the skin printer 10 mounted on the docking station 100 in a wired manner or a wireless manner.

The docking station 100 transfers the power stored in the battery module to the skin printer 10 in a wired or wireless manner, thereby charging the skin printer 10.

According to an embodiment, the docking station 100 may directly transfer the power received from the external power to the skin printer 10 in a wired manner or a wireless manner to charge the skin printer 10.

The docking station 100 may include at least one light emitting unit or a display to display a charging state of the skin printer 10. The docking station 100 displays the charging state of the skin printer 10 by using the color of the light emitting unit, whether light is emitted or the text or image displayed on the display.

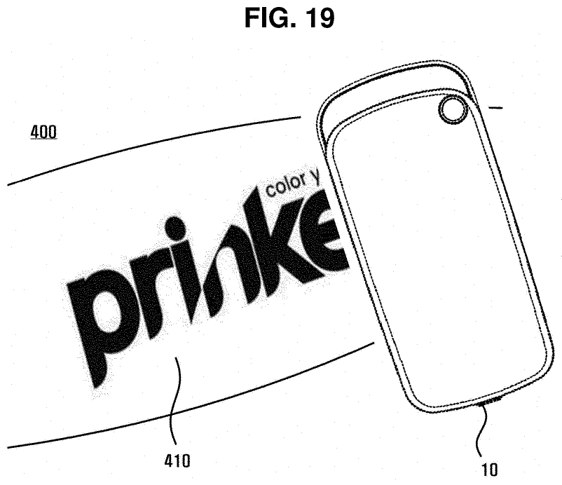

FIG. 17 illustrates a skin printer system according to an embodiment.

Referring to FIG. 17, a skin printer 10 and a user client 200 are illustrated.

FIG. 17 is a schematic view illustrating a system for providing a business assistance service according to an embodiment.

According to an embodiment, the user client 200 refers to a computer or a program running on the computer.

According to the embodiments disclosed herein, a computer is used as a concept of including all types of devices including at least one processor. For example, a computer refers to a desktop, laptop (laptop), smartphone or tablet PC.

The user client 200 transmits at least one image to the skin printer 10 such that the skin printer 10 may output the image.

According to an embodiment, the control operation required for the output of the skin printer 10 may be performed independently by the skin printer 10, and at least partial control operation may be performed by the user client 200.

According to an embodiment, the skin printer 10 and the user client 200 may be connected with each other by a network or a short range wireless communication method, but the inventive concept is not limited thereto.

For example, the skin printer 10 and the user client 200 may be connected with each other using Bluetooth (including BLE), but the inventive concept is not limited thereto.

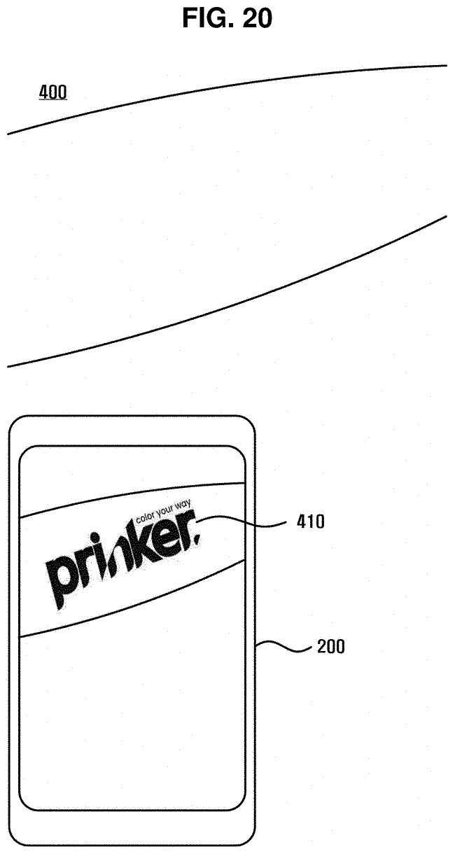

FIG. 18 is a flowchart illustrating a method for guiding an output of a skin printer by a computer according to an embodiment.

The method illustrated in FIG. 18 includes steps that are processed in time series in the user client 200 illustrated in FIG. 17.

In step S310, the user client 200 acquires an image to be output from the skin printer 10.

The user client 200 transmits at least some or the entire portion of the obtained image to the skin printer 10.

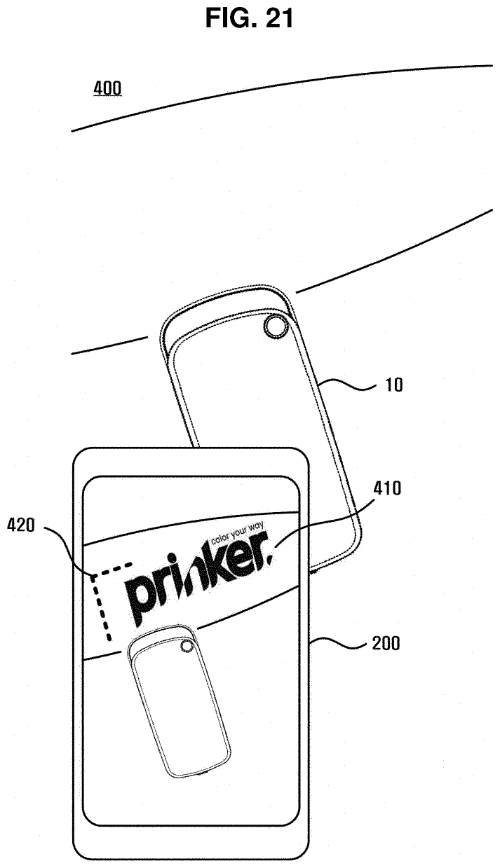

FIG. 19 is a view illustrating that the skin printer 10 outputs an image 410 to a body part 400 of a user.

The skin printer 10 outputs the image 410 received from the user client 200 to one position of the body part 400 of the user. The skin printer 10 outputs the image 410 while sliding in a specific direction from one position of the body part 400 of the user. The skin printer 10 measures the moving speed of the skin printer 10 and adjusts the output speed of the image 410 based on the measured speed.

In the disclosed embodiment, determining the output start point and the output direction of the skin printer 10 is an important task such as determining the output of the image 410 to be printed on the body part 400. However, it is not easy for the user to output the image 410 at the correct position by estimating the position of the nozzle positioned at the bottom of the skin printer 10 and the size of the image to be output. Therefore, FIG. 18 illustrates a method in which the user client 200 guides the output of the skin printer 10.

In operation S320, the user client 200 acquires a captured image including at least a part of a body part to which the image acquired in operation S310 is to be output.

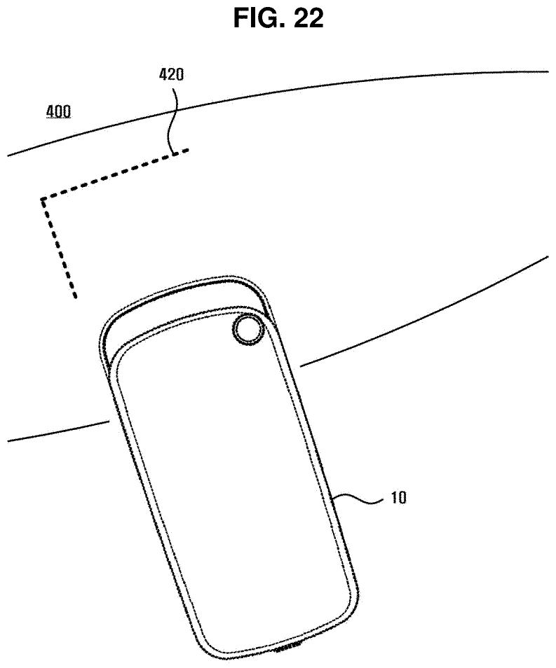

FIG. 20 illustrates that the user client 200 captures a part of a body part 400. Referring to 20, the user client 200 may capture an arm of a user.

According to an embodiment, the captured image is displayed on the user client 200. In addition, an image 410 to be output may be superimposed or synthesized on the captured image to be displayed. A detailed method for displaying the image 410 together on the captured image will be described later.

In step S330, the user client 200 determines the position of the body part 400 on which to the image 410 is output. Referring to FIG. 20, the user client 200 may generate and display a simulation image including the image 410 on one position of the body part 400 by applying augmented reality to the captured image.

The user client 200 may determine a position of the body part 400 onto which the image 410 is to be output, by using the simulation image. For example, the user client 200 determines the position of the image 410 to be output on the body part 400 displayed on the captured image by using the simulation image, and displays the determined position on the simulation image. The user may determine a position of the body part 400, onto which the image 410 is to be output, by using the simulation image displayed on the user client 200.

The user client 200 displays a simulation image, in which an image 410 is displayed, on at the determined position of the body part 400.

According to an embodiment, the user client 200 is connected to a head mounted display (HMD), which is able to display a virtual reality, an augmented reality image, or a mixed reality image, to display the simulation image according to the embodiment disclosed therein, by using the HMD. Similarly, the user client 200 may acquire an image captured using a camera provided in the HMD, and may generate a simulation image using the acquired image.

In the step S340, the user client 200 determines the start position and the direction for outputting the image on the body part 400 for outputting the image 410 based on the position determined in step S330.

For example, the user client 200 may determine a position and a direction in which the skin printer 10 starts to output an image on the body part 400, by taking into consideration of the size and the nozzle position of the skin printer 10, such that the image 410 is output as in the simulation image.

In step S350, the user client 200 may output the output start position and the output direction, which are determined in step S340.

According to an embodiment, the user client 200 may output the output start position and the output direction determined in step S340 by using the display of the user client 200 or the display of the HMD connected with the user client 200. For example, the user client 200 may display a simulation image including information obtained by visualizing the output start position and the output direction determined in step S340.

For example, the user client 200 displays the output start position and the output direction of the skin printer 10 on a position on the body part 400 by applying augmented reality to the image taken using the user client 200 or HMD.

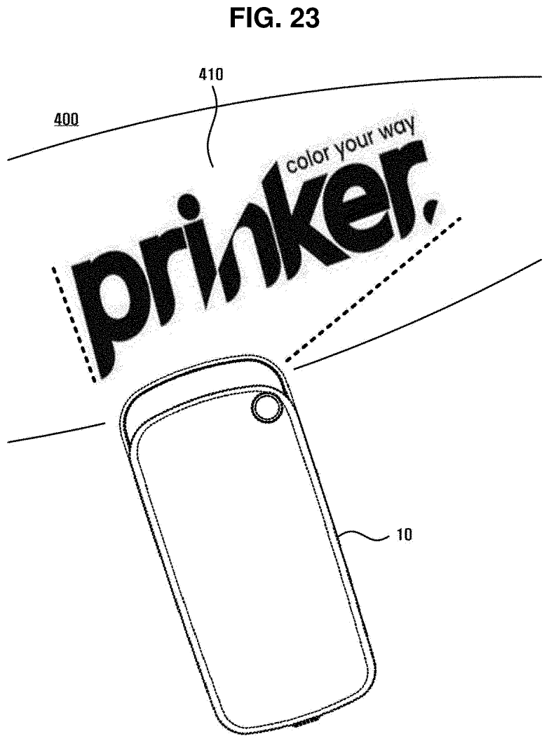

Referring to FIG. 21, the user client 200 may display the determined output position of the image 410 by using the image of the body part 400, and may generate and display a simulation image including a guide 420 displaying the output start position and the output direction of the skin printer 10 such that the image 410 is output to the determined output position.

According to one embodiment, the user client 200 acquires an image of the body part 400 of the user, which is captured by the skin printer 10, and determines the position and direction of the skin printer 10 from the acquired image. The user client 200 may determine whether the determined position and direction of the skin printer are matched the output start position and the output direction determined in step S340, and may provide feedback.

For example, when the skin printer 10 is positioned at the correct position and the correct direction, the user client 200 may display feedback indicating that the output is allowed, or may output, using voice and vibration, the feedback. In addition, when the position or the direction of the skin printer 10 is incorrect, the user client 200 may output, using an image or a voice, a feedback to indicate moving the skin printer 10 or a feedback to change the direction of the skin printer 10 to a specific direction.

According to an embodiment, the user client 200 may transmit the information on the output start position and the output direction to the skin printer 10. The information on the output start position and the output direction transmitted to the skin printer 10 includes information for projecting the output position and the output direction to the body part 400 using the projector provided in the skin printer 10.

According to an embodiment, skin printer 10 has at least one projector module. The projector module may be a module capable of outputting image data as light, or may be a module capable of outputting a point, an image or a grid indicating a specific position using a laser, and the specific structure thereof is not limited.

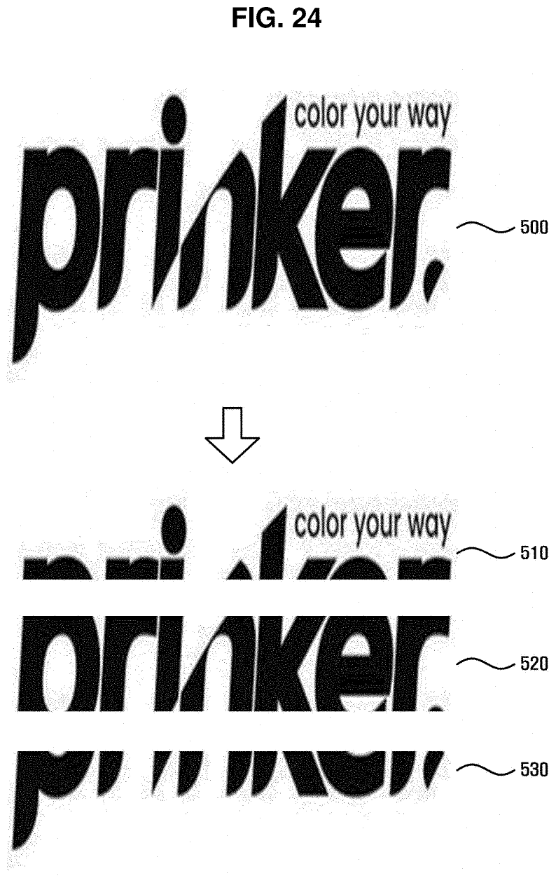

As illustrated in FIG. 22, the skin printer 10 may project a guide 420 indicating an output start position and an output direction of the skin printer 10 at a position on the body part 400.

According an embodiment, the skin printer 10 or the user client 200 updates the information for projecting the guide 420 as the skin printer 10 moves. Accordingly, even if the skin printer 10 is moved, the guide 420 may be fixedly displayed on one position of the body part 400.

In addition, the skin printer 10 may project a printout of the image 410 on the determined position of the body part 400 of the user, by using the image 410 obtained from the user client 200 and information on the output position and the output direction of the image 410.

According to an embodiment, the user client 200 or the skin printer 10 may calculate and display a result output when the printing is started at the relevant position, when the skin printer 10 is positioned on a position of the body part 400.

For example, when the skin printer is positioned at an output start position, and when an output is started at the relevant position, the virtual simulation result of the result to be output to the skin may be showed.

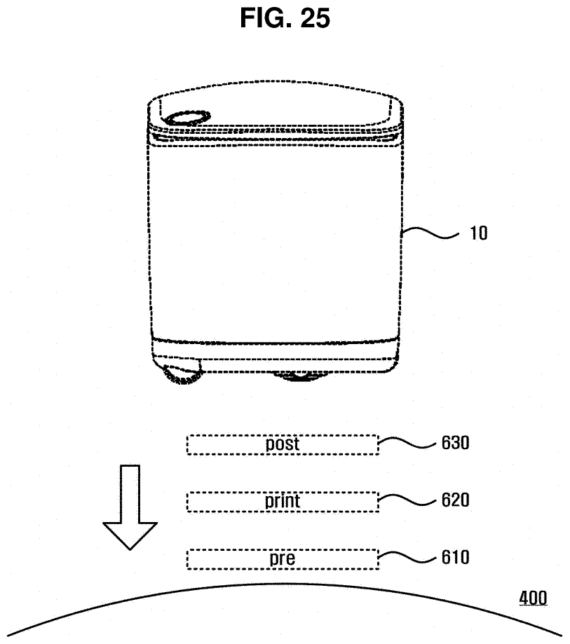

Similarly, the user client 200 may display the result of the image 410, when starting the output from the position and the direction of the skin printer 10, by using the augmented reality image or the projector of the skin printer 10 as illustrated in FIG. 23.

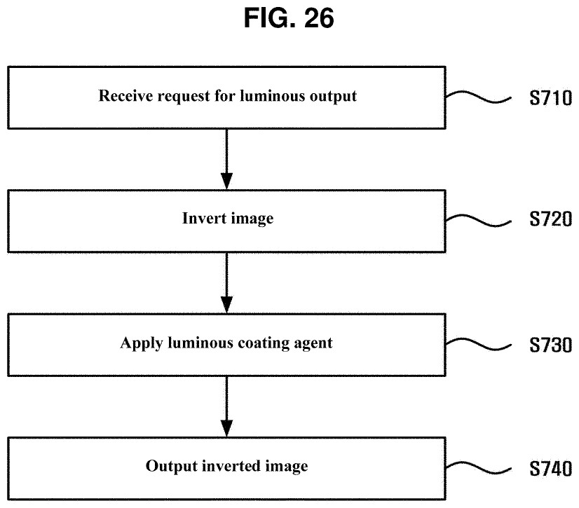

FIG. 24 illustrates that the user client splits an image.

According to an embodiment, the user client 200 may split an image 500 into a plurality of images 510 to 530 having heights less than a specific reference value when the height of the image 500 exceeds the reference value.

The skin printer 10 outputs an image while sliding in one direction by using one or more nozzles. In this case, although the skin printer 10 may output the image through the sliding operation even if the longitudinal length of the image is long, the skin printer 10 may not output the image in one sliding operation when the transverse length of the image is longer than the nozzle length of the skin printer 10.

Thus, when the height of the image 500 is longer than the length of the nozzle, the user client 200 splits the image 500 into the plurality of images 510 to 530 having heights shorter than the length of the nozzle.

The user client 200 may determine the output position of each of the images 510 to 530 such that the images 510 to 530 may be combined to form one large image 500.

The user client 200 determines an output start position and the output direction for the position of each of the images 510 to 530.

The user client 200 sequentially outputs the output start position and the output direction of each of the images 510 to 530, as in the method described with reference to FIGS. 17 to 23.

For example, the user client 200 outputs the output start position and the output direction of the split image 510, and after the skin printer 10 completes the output of the split image 510, the skin printer 10 outputs the output start position and the output direction of the next divided image.

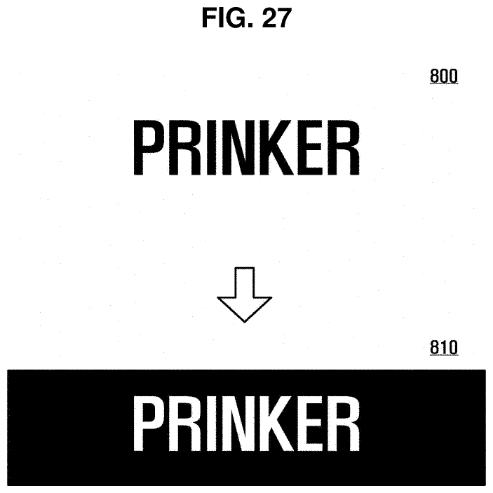

FIG. 25 illustrates that a skin printer outputs a plurality of layers on a body part.

According to an embodiment, the method for outputting an image to the skin by the skin printer 10 may include a preprocessing step, an output step, and a post processing step. For example, a coating agent may be applied in the preprocessing step, an image may be output on the coating area in the output step, and then a coating agent may be applied to coat an image in a post processing step.

In addition, when outputting a circuit or the like using the conductive ink, a coating agent that does not harm the skin may be used in the preprocessing and post processing steps.

In addition, an ink, which includes a color changeable ink according to the temperature, may be output to the body such as the forehead to check the body temperature in real time by using color. For example, the outputting method using the color changeable ink may be used for a patient in an emergency room or a hospital, or for a small kid.

According to an embodiment, a skin printer may be used to output dermal administration color to the skin.

In this case, a lamination structure is used such that the drug is not excessive absorbed at one time. In other words, a drug layer and a delay layer for delaying drug absorption may be alternately output to the skin.

According to an embodiment, the printing based on the lamination structure may be performed by using a plurality of nozzles having mutually different drugs, or may be performed through several printings by moving the skin printer several times at the same section.

According to an embodiment, the skin printer 10 may output an image including a plurality of layers to the body part 400. For example, the plurality of layers may include a preprocessing layer 610, an output layer 620, and a post processing layer 630.

When receiving a request for outputting an image including a plurality of layers, the user client 200 controls the skin printer 10 to output a plurality of layers.

According to an embodiment, as images corresponding to each of the plurality of layers may be output from different nozzles, the skin printer 10 may be controlled to output the plurality of layers in a single sliding operation.

According to another embodiment, as the plurality of layers included in the image are output one by one whenever the skin printer 10 performs one sliding operation, the image including the plurality of layers may be output when the skin printer 10 performs the sliding operation several times at the same position of the body part 400.

In this case, the user client 200 performs the method for guiding the output position and the output direction guide as described with reference to FIGS. 17 to 23 such that the plurality of layers 610 to 630 may be repeatedly output at the same position.

According to an embodiment, the user client 200 and the skin printer 10 may output a nightglow image to the body part 400. Hereinafter, a method for outputting a nightglow image by a skin printing system including the user client 200 and the skin printer 10 will be described.

In the present specification, “nightglow” refers to the overall luminescence phenomenon including nightglow, which is a phenomenon of emitting light in a dark place without light, fluorescence, which is a phenomenon of emitting light only when receiving light, and phosphorescence, which is a phenomenon of having afterglow for a long time

In detail, the “luminescence” refers to a phenomenon in which a material receives energy by electromagnetic waves, heat, and friction, and emits light of a specific wavelength with the received energy.

Although a phenomenon of stopping emitting light immediately when the energy supply is cut off from the excitation source is called “fluorescence”, and a phenomenon of maintaining afterglow is called “phosphorescence”, both phenomena are clearly not distinguished and called “fluorescence”.

In the present specification, an ink, a coating agent, and a nightglow material used for skin printing contain only ingredients that are harmless to the human body, and the skin printing employs only a substance approved for a human body (skin) in a public institution such as the United States FDA or the Korea Food and Drug Administration Use according to the embodiment.

According to an embodiment, the nightglow substance in the present specification refers to at least one of FDA-approved substances.

For example, according to the FDA (21 CFR 74.2254, 74.2260, 74.2261, 74.2321, 74.2322, 74.2327, 74.2328), the fluorescent color approved for use in the human body, that is, cosmetics is limited to D & C Orange No. 5, No. 10, No. 11 and D & C Red No. 21, No. 22, no. 27, No. 28.

In addition, according to the FDA (21 CFR 73.2995), the glow-in-the-dark color additive approved for use in the human body, that is, cosmetics, is only luminescent zinc sulfide.

According to a preferred embodiment of the inventive concept, only the above materials approved by the FDA may be used to perform a nightglow skin printing method according to an embodiment of the inventive concept. However, the type of materials that may be used in the inventive concept is not limited thereto, and various materials, such as additionally developed or found materials or additionally approved materials, may be used in the embodiments of the inventive concept.

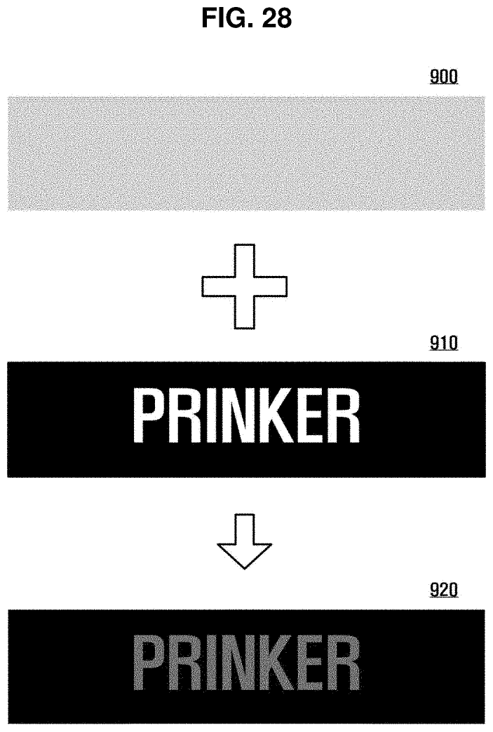

FIG. 26 is a flowchart illustrating a nightglow skin printing method.

In step S710, the user client 200 receives a request for a nightglow output.

For example, the user client 200 may receive at least one image and information for requesting to output the image as a nightglow image. According to an embodiment, the user client 200 may receive an image for a nightglow output.

Hereinafter, a method for receiving a general image by the user client 200 and converting the general image into an image for a nightglow output will be described with reference to FIG. 26.

In step S720, the user client 200 inverts the image obtained in step S710 and transmits the inverted image to the skin printer 10.

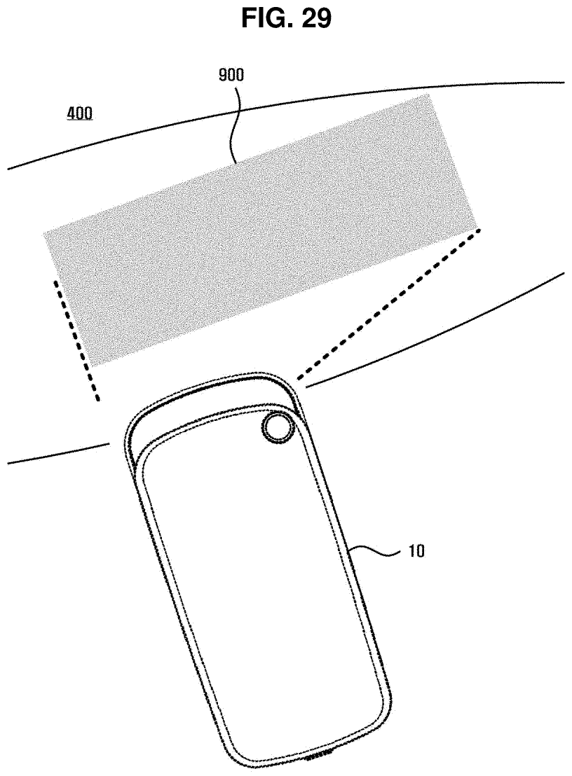

FIG. 27 illustrates that a user client inverts an image.

According to an embodiment, the user client 200 inverts an image 800. According to an embodiment, an inverted image 810 is an image in which the background part included in the image 800 is processed in black and the image part is processed as blank.

According to an embodiment, the user client 200 binarizes the image 800 in black and white, and inverts the binarized image. For example, when the image 800 is a color image, the user client 200 may convert the image 800 into a black and white image and invert the converted image. When the black and white image is inverted, the inverted image 810 includes a black portion and a white portion. The user client 200 or the skin printer 10 may process white portions as blanks and may not output ink.

Further, in the inverted image 810, the color of a portion other than a white portion is not limited to black, but is displayed and output in other various colors through user selection or automatically.

For example, the color of the portion other than white (blank) portion in the inverted image 810 may be determined depending on the skin color of the user. For example, the color of the portion other than the white (blank) portion in the inverted image 810 may be determined as a color similar to the skin color of the user or a darker color similar to the skin color of the user.

In addition, for the color of the portion other than white (blank) portion in the inverted image 810, other various colors may be selected and applied through the user selection. A plurality of colors may be selected to be displayed and output with respect to the portion other than the white (blank) portion in the inverted image 810.

In addition, at least one image, which is not a simple combination of colors, may be displayed and output in a portion other than the white (blank) portion in the inverted image 810.

For example, when outputting an image including a space for displaying a nightglow image, the image is viewed when it is bright, the nightglow image is viewed when it is dark.

According to an embodiment, the user client 200 may binarize the image 800 to black and white, such that all pixels included in the image 800 are black or white. The image 800 may be converted to a grayscale image including the intermediate colors between black and white.

In the case of the image 810 obtained by inverting the grayscale image, the skin printer 10 may output the image 810 by adjusting the concentration of the ink depending on colors.

In step S730, the skin printer 10 or a spray device provided separately from the skin printer 10 applies a nightglow coating agent to one region of the body part 400 of the user.

The nightglow coating agent includes a nightglow substance that may emit light even in a dark space. In the present specification, the nightglow material collectively refers to all types of materials that self-emits light, emits stored light, or reflect light at night like a fluorescent material or a luminescent material.

According to an embodiment, the skin printer 10 includes at least one cartridge containing ink to block the light from the nightglow coating agent and at least one nozzle to discharge the ink contained in the cartridge.

In step S740, the skin printer 10 outputs the inverted image 810 received from the user client 200 to the area in which the nightglow coating agent is applied on the body part 400. In this case, the skin printer 10 may output the inverted image using ink (light blocking ink) to block the light of the coating agent.

The skin printer 10 outputs the light blocking ink to a black area of the inverted image 810. When the inverted image 810 is formed in grayscale, the skin printer 10 adjusts an amount of the light blocking ink depending on the brightness of each region.

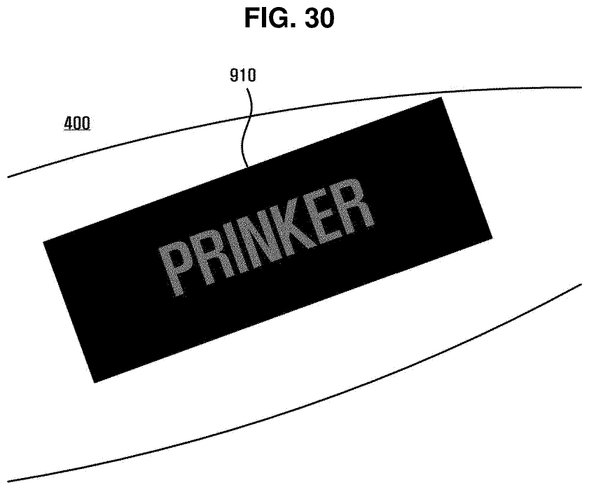

FIG. 28 illustrates that a nightglow coating agent 900 is applied, an inverted image 910 is output on the nightglow coating agent 900, and a nightglow image 920 is output

Regarding the nightglow image 920, a non-blocking portion of the image 910 having the light blocking ink and output on the nightglow coating agent 900 is exposed to the outside, such that the exposed portion glows as a nightglow image at a darker place.

According to an embodiment, the skin printer 10 further includes a cartridge containing a nightglow coating agent and a nozzle to discharge the nightglow coating agent contained in the cartridge. The nozzle to discharge the nightglow coating agent is provided in front of at least one nozzle to discharge the light blocking ink in the forward direction of the skin printer 10.

In this case, the skin printer 10 proceeds in the printing direction while outputting the nightglow coating agent on a skin through a front nozzle to discharge the nightglow coating agent, and outputting an image on the nightglow coating agent through the nozzle to discharge the light blocking ink.

According to another embodiment, the skin printer 10 further includes a cartridge containing a nightglow coating agent and a nozzle to discharge the nightglow coating agent contained in the cartridge. The nozzle to discharge the nightglow coating agent is provided in back of at least one nozzle to discharge the light blocking ink in the forward direction of the skin printer 10.

In this case, the skin printer 10, which slides in the forward direction while discharging the image and the nightglow coating agent, outputs the nightglow image by discharging the nightglow coating agent to a portion, which is not coated with the light blocking ink, of the output image.

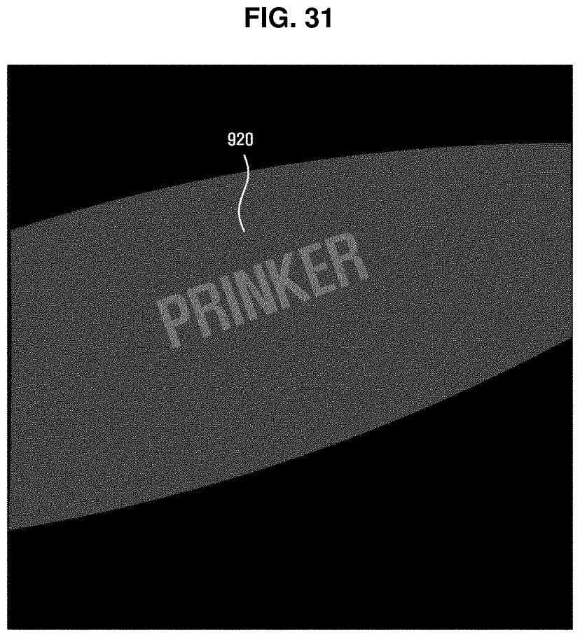

FIG. 29 illustrates a method for recognizing an area coated with a nightglow coating agent 900 by the skin printer 10 or the user client 200 and for guiding outputting of an image.

The skin printer 10 or the user client 200 may recognize an area coated with the nightglow coating agent 900 by using at least one sensor (for example, an optical sensor) provided in the skin printer 10 or a camera provided in the user client 200.

The user client 200 or the skin printer 10 may determine a position on which the inverted image 910 is output such that an ink to block the light from the nightglow coating agent 900 is output to the area coated with the nightglow coating agent 900.

The user client 200 or the skin printer 10 performs an output guide function of outputting the inverted image 910 to the position coated with the nightglow coating agent 900 in a method for determining an image output position, and guiding an output start position and an output direction for outputting an image to the determined image output position, as described with reference to FIG. 17 to FIG. 23.

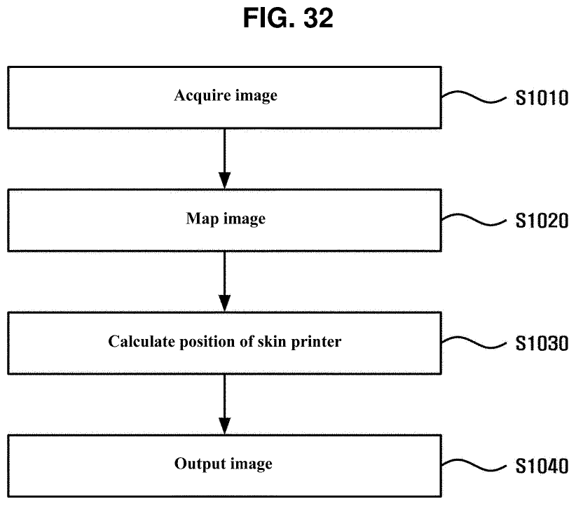

FIGS. 30 and 31 illustrate that the skin printer 10 outputs the inverted image 910 on the nightglow coating agent 900 applied to the body part 400, and thus, the outputting of the nightglow image 920 is completed.

According to an embodiment, the user client 200 may acquire an image inverted for nightglow output, and transmit and output an image, which is directly obtained without image inversion, to the skin printer 10.

According to an embodiment, the skin printer 10 may recognize an area, to which the coating agent is applied, of the body part 400 of the user depending on the above-described method, and may determine a position to which the image is to be output.

For example, the skin printer 10 may first apply a coating agent to help the hardening and the maintaining of the ink before outputting the ink to the body part 400. The skin printer 10 or the user client 200 may recognize an area applied with the coating agent by using at least one sensor (for example, an optical sensor) provided in the skin printer 10 or a camera provided in the user client 200.

The user client 200 or the skin printer 10 determines the output position of the image such that that the image is included in the area applied with the coating agent, and guides the output start position and the output direction to allow the image output at the determined position.

According to an embodiment, the user client 200 may invert an image automatically or by requesting the selection of a user, when it is recognized that the coating agent applied to the body part 400 is a nightglow coating agent, even if there is absent a separate nightglow output request. The user client 200 transmits the inverted image to the skin printer 10 and determines a position to which the inverted image is to be output such that the inverted image includes an area applied with the nightglow coating agent. The user client 200 may guide the output start position and the output direction to allow the output of the inverted image to the determined position.

In addition, the user client 200 or the skin printer 10 may recognize an area, which is coated with a fluorescent material, of the skin, and may provide an output guide to the user. For example, the skin printer 10 may include an LED to react the fluorescent material, such that the user recognizes the area coated with the fluorescent material with naked eyes of the user. In addition, the skin printer 10 further includes at least one light receiving device such that the skin printer or a mobile terminal may automatically recognize the area coated with the fluorescent material and may provide the guide of the output start position to the user.

Hereinafter, a method for splitting and outputting an image having a longitudinal length longer than that of the nozzle of the skin printer 10 will be described with reference to FIG. 24.

Hereinafter, a method for outputting an image having the longitudinal length longer than that of the nozzle of the skin printer 10 using a multipath output function of the skin printer 10 will be described.

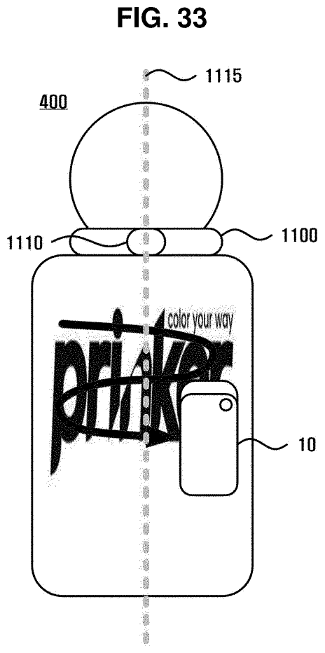

FIG. 32 is a flowchart illustrating a method for performing a multipath output by a skin printer according to an embodiment.

The multipath output is to a method for outputting an image by performing a sliding operation multiple times in a transverse direction while moving in a longitudinal direction, instead of outputting the image by performing the sliding operation once in one direction. According to an embodiment, the skin printer 10 may output the image while moving in a diagonal direction.

According to an embodiment disclosed herein, the skin printer 10 outputs an image while moving through the hand of a person, the skin printer 10 may cause the error in measuring a moving speed and a position. To this end, the skin printer may be configured to measure the moving speed, to control the output speed of the ink based on the moving speed, and to output an image uniformly. In addition, the skin printer or the mobile terminal may further include an interface to measure the moving speed and to guide the user to adjust the moving speed.

In particular, when performing the multipath output, since cut surfaces of multiple different partial images should be connected to have continuity, a specific method for controlling the output position of the skin printer 10 is required.

Each step illustrated in FIG. 32 may be performed by the skin printer 10 or may be performed by the user client 200 such that the user client 200 may control the output of the skin printer 10.

Although the following description will be made in that the skin printer 10 performs operations illustrated in FIG. 32, at least some or the entire portion of operations to be described below may be performed by the user client 200.

In step S1010, the skin printer 10 obtains an image to be output.

According to an embodiment, the image obtained by the skin printer 10 is an image having a longitudinal length longer than that of the nozzle of the skin printer 10.

In step S1020, the skin printer 10 maps the image acquired in step S1010 to the body part 400.

For example, the skin printer 10 may map virtual coordinates onto the body part 400 and may determine a position, to which the image obtained in step S1010 is output, using the virtual coordinates. For example, the skin printer 10 matches each part of the image with virtual coordinates, to output a partial image corresponding to a specific coordinate of the skin printer 10, when the skin printer 10 outputs the image at the specific coordinates.

In step S1030, the skin printer 10 calculates the position of the skin printer 10 for outputting an image on the body part 400. In this case, the position of the skin printer 10 may be calculated as coordinates corresponding to a moving distance from at least one virtual axis, based on the at least one virtual axis set on the body part.

For example, on the assumption that a position of starting the output corresponds to coordinates (0), the skin printer 10 measures the moving distance of the skin printer 10 after starting outputting. For example, the skin printer 10 measures the number of revolutions of the main roller 41 to measure the moving distance of the skin printer 10. When the skin printer 10 is moved by ‘d1’, the coordinates of the skin printer 10 may be ‘d1’.

In addition, the skin printer 10 may set a plurality of virtual axes. For example, a skin printer 10 may set a virtual x-axis and a virtual y-axis. In this case, the origin may be referred to as (0,0), and the position of the skin printer may be set as two-dimensional coordinates (x, y).

According to an embodiment, unless there is a separate additional device, the coordinates of the skin printer 10 may be calculated only as relative coordinates, instead of absolute coordinates. For example, when there is no sensor or other units to determine the exact position of the skin printer 10, the skin printer 10 may calculate the relative coordinates by measuring the moving distance from an origin, a virtual axis, or a starting position to measure the relative coordinates based on the moving distance.

However, the relative coordinates may be inferior in accuracy to the absolute coordinates due to errors of a unit to measure the moving distance, and the curvature of the skin. In particular, as the moving distance becomes longer, the error of the relative coordinate to the absolute coordinate may be increased.

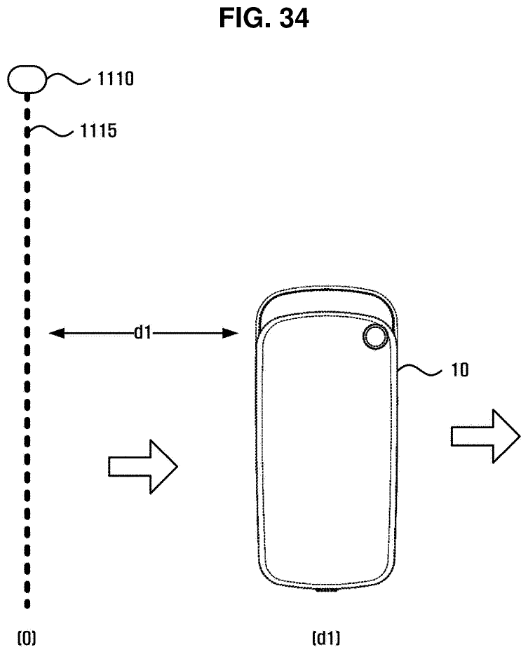

Therefore, according to an embodiment disclosed therein, a multipath printing system includes a sensor device 1100, which is provided in the form of a wearable device put on one position of the body part 400 of the user, as illustrated in FIG. 33.

For example, the sensor device 1100 is put in the form of a wearable device on the neck of the user and includes at least one sensor 1110 to sense the skin printer 10.

For example, the sensor 1110 may include an infrared sensor or an ultrasonic sensor.

The sensor 1110 corresponds to the virtual axis 1115. For example, when a user wants to output a large image on the back of the user, the sensor device 1100 is put on the neck of the user, and a virtual axis 1115 is positioned at the center of the back using the sensor 1110 included in the sensor device 1100.

According to an embodiment, the skin printer 10 detects that the skin printer is positioned on the virtual axis 1115 using the sensor 1110. For example, the skin printer 10 may detect the presence of the sensor 1110, or the sensor 1110 may detect the presence of the skin printer 10 such that the sensing result may be transmitted to the skin printer 10.

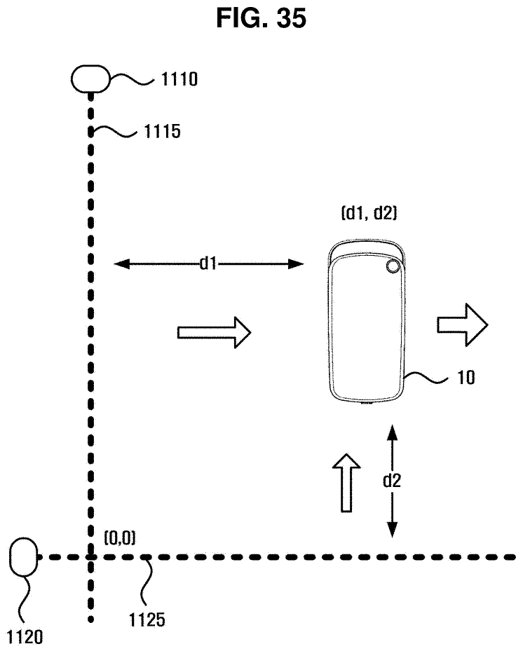

According to an embodiment, when it is sensed that the skin printer 10 is positioned on the virtual axis 1115, the coordinates of the skin printer 10 are reset to the coordinates corresponding to the virtual axis 1115. For example, as illustrated in FIG. 34, when the coordinate corresponding to the virtual axis 1115 is zero and when the skin printer 10 is positioned on the virtual axis 1115 or passes through the virtual axis 1115, the coordinates of the skin printer 10 is reset to zero.

Thereafter, the skin printer 10 calculates the coordinates of the skin printer 10 according to the moving distance from the virtual axis 1115 of the skin printer 10. For example, when the skin printer 10 moves from the virtual axis 1115 by ‘d1’, the coordinates of the skin printer 10 may be set to ‘d1’.

When using the relative coordinates based on the moving distance of the skin printer 10, the error is accumulated, so it is difficult to output an image a correct position.

Accordingly, according to an embodiment disclosed herein, when the virtual axis is set using at least one sensor device, and when the skin printer 10 passes the virtual axis, the coordinates are reset to the coordinates set in the virtual axis, thereby preventing the errors from being accumulated.

According to an embodiment, the skin printer 10 may calculate coordinates in two or more dimensions by setting a plurality of virtual axes by using a plurality of sensor devices. In addition, the skin printer 10 may calculate the direction of the skin printer 10 using a plurality of sensor devices.

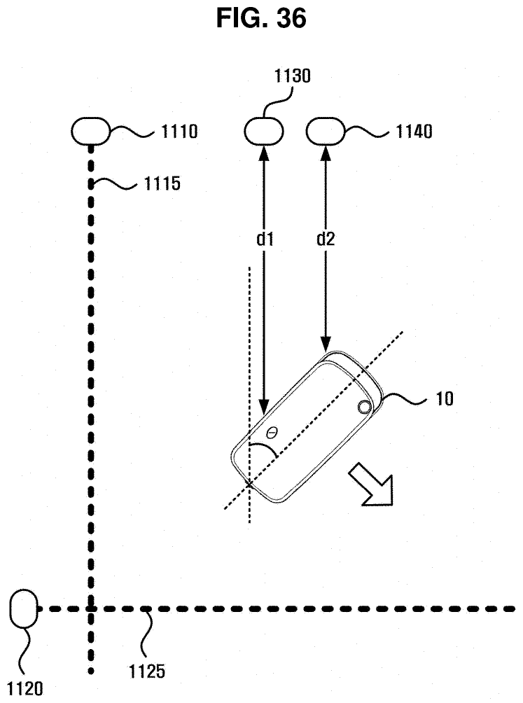

For example, as illustrated in FIG. 35, a skin printing system that performs a multipath output includes a first sensor 1110 corresponding to a virtual first axis 1115 and a second sensor 1120 corresponding to another virtual first axis 1125.

For example, the first sensor 1110 is provided in the sensor device 1100 in the form of a wearable device that can be worn on the neck, and the second sensor 1120 may be provided in a sensor device in the form of a wearable device to be attached to the skin, or put on the arm.

For example, the virtual first axis 1115 may be the y-axis, and the virtual second axis 1125 may be the x-axis.

The virtual axes illustrated in FIG. 35 and coordinate planes generated based on the virtual axes are provided for the illustrative purpose, and a method for generating the coordinate plane by arranging a plurality of virtual axis is not limited thereto.

For example, the plurality of virtual axes may be perpendicular to each other, but may be parallel to each other, or may be arranged to have a specific angle other than a right angle.

According to an embodiment, the skin printer 10 senses that the skin printer 10 is positioned on a virtual first axis 1115 or a virtual second axis 1125 using the first sensor 1110 or the second sensor 1120.

When the skin printer 10 is positioned on the virtual first axis 1115 or the virtual second axis 1125, a directional component, which is perpendicular to an axis on which the skin printer 10 is positioned, in the coordinates of the skin printer 10 is reset as a coordinate corresponding to the axis on which the skin printer 10 is positioned.

For example, when the skin printer 10 is positioned on the first axis 1115, a component, which is perpendicular to the first axis 1115 in the coordinates of the skin printer 10, that is, an x-axis component may be reset zero. Similarly, when the skin printer 10 is positioned on the second axis 1125, the component, which is perpendicular to the second axis 1125 in the coordinates of the skin printer 10, that is, a y-axis component may be reset to zero.

The skin printer 10 calculates the coordinates of the skin printer 10 based on the moving distance from the virtual first axis 1115 or the virtual second axis 1125 of the skin printer 10.

For example, when it is determined that the skin printer 10 is moved by the d1 from the first axis 1115 and by d2 from the second axis 1125, the skin printer 10 may set coordinates (d1, d2) of the skin printer 10.

According to an embodiment, the skin printer 10 may move in a diagonal direction. In this case, the skin printer 10 may calculate the moving distances in the direction of the first axis 1115 and the direction of the second axis 1125 based on the moving distance and angle in the diagonal direction.

In step S1040, the skin printer 10 outputs at least a portion of the image, mapped to the position of the skin printer 10 calculated in step S1030.

According to an embodiment, the skin printer 10 determines the moving direction of the skin printer 10 using a plurality of sensor devices.

The skin printer 10 outputs at least a portion of the image mapped in the moving direction of the skin printer 10 from the position of the skin printer 10.

According to an embodiment, the skin printing system determines the angle of the skin printer 10 using a plurality of sensor devices.

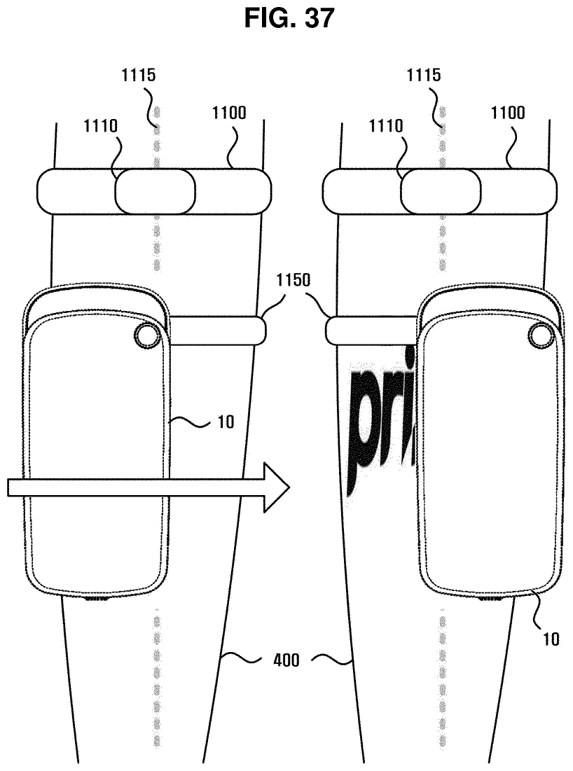

FIG. 36 illustrates a method for determining an angle of the skin printer 10 using a plurality of sensor devices.

According to an embodiment, the skin printer 10 may include at least one gyro sensor to detect the rotation of the skin printer 10, but the skin printer 10 may include various sensors to sense the rotation of the skin printer 10 without being limited thereto.

In addition, the skin printing system includes one or more sensors 1110 and 1120 to be used to determine the position and the angle of the skin printer 10.

According to an embodiment illustrated in FIG. 36, the skin printer 10 may determine the position of the skin printer 10 based on the distance from each of the first axis 1115 and the second axis 1125, and may determine an angle of the skin printer 10 using a sensor provided in the skin printer 10.

According to an embodiment, the skin printer 10 may determine the angle of the skin printer 10 using a plurality of sensor devices.

For example, the skin printing system includes one or more distance sensors that may measure the distance to the skin printer 10, and the one or more distance sensors measure the distance to one point of the skin printer 10. The skin printer 10 may calculate the angle of the skin printer, based on the distance to the skin printer 10 obtained from each of the one or more distance sensors.

For example, the skin printing system further includes a third sensor 1130 and a fourth sensor 1140. On the assumption that the distance between the third sensor 1130 and the skin printer 10 is ‘d1’, and the distance between the fourth sensor 1140 and the skin printer 10 is ‘d2’, the inclined degree of the skin printer 10 may be found using the difference between ‘d1’ and ‘d2’. In addition, the skin printer 10 may calculate an angle of the skin printer 10 using the distance between the third sensor 1130 and the fourth sensor 1140.

For example, as described above with reference to FIGS. 11 and 12, the angle of the skin printer 10 may be calculated using the following equation.

g1=d1−d2

a=a tan(g1/g2)

In the above equation, g2 is the distance between the third sensor 1130 and the fourth sensor 1140.

According to an embodiment, as the skin printer 10 calculates the angle of the skin printer 10, and moves in a direction perpendicular to the calculated angle, the skin printer 10 outputs at least a portion of an image mapped in a direction perpendicular to the angle of the skin printer 10 from the position of the skin printer 10.

According to an embodiment, the skin printer 10 may perform single path and multipath printing for other parts than the back.

For example, the skin printer 10 may perform printing for the arm or leg, In this case, it may be difficult to perform a control operation to constantly output the image for the body part with a large curvature as compared to that of the back.

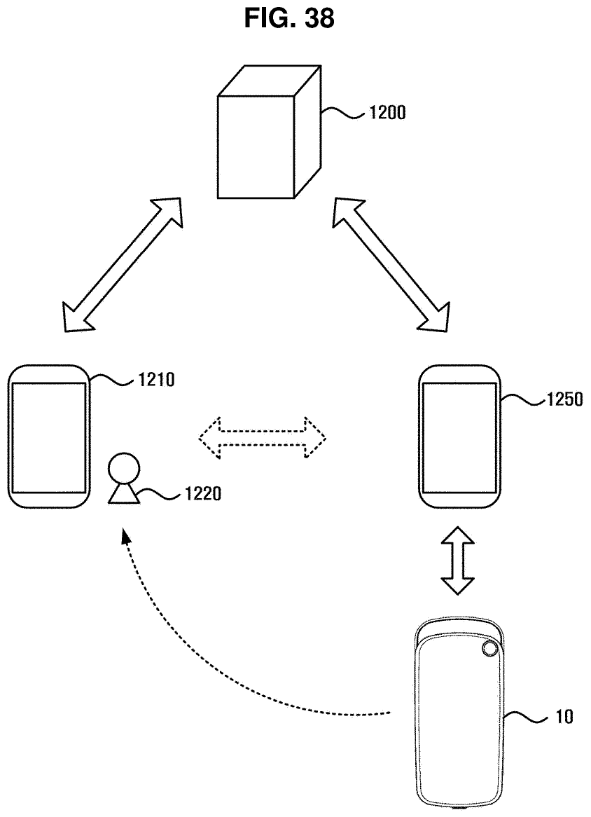

FIG. 37 illustrates an assisting device allowing the skin printer 10 to be applied to a part with a large curvature.

According to an embodiment, a guide device may be further provided to be put on or attached to a body to assist the movement of the skin printer 10.

For example, a guide device 1150 may be further provided in the form of a rail to allow the user to sliably move the skin printer 10 in one direction stably, or may be further provided in the form of assisting outputting an image as the guide device 1150 is put on the arm to rotate in the transverse direction.

In addition, a guide device is further provided to be mounted on the back of a user to allow the user to stably move the skin printer in left and right directions, or to move the skin printer one by one such that a next image is output to a correct position.

In addition to the above-described example, as a guide device is further provided to correspond to a structure used to output one larger image by moving a printer head (nozzle) left, right, up and down in a typical printer, the guide device may be used together with the skin printer 10.

According to an embodiment, the guide device 1150 may be mounted together with the wearable sensor device 1100 to allow the skin printer 10 to perform multipath output even for a part, such as an arm or a leg, having a large curvature.

Hereinafter, a method for providing a marketing service using a skin printer according to an embodiment disclosed herein will be described.

Recently, company booths are placed at a variety of event sites, such as fairs, performances, athletics, and music festivals, having many floating populations, and marketing is performed in manners of providing promotional materials for customers, giving a specific mission, and providing rewards in return.

Among types of marketing, the most commonly used manners are a manner of allowing a user to download and install an application and to sign up for the application, and of providing a specific reward to the user, and a manner of producing an advertisement effect by distributing stickers formed by adding advertising texts or cooperate logos to the favorite images of people, such that the people may voluntarily put the stickers on their bodies, clothes, or bags.

The following description will be made regarding a marketing service using a skin printer, capable of simultaneously producing two advertisement effects described above according to embodiments.

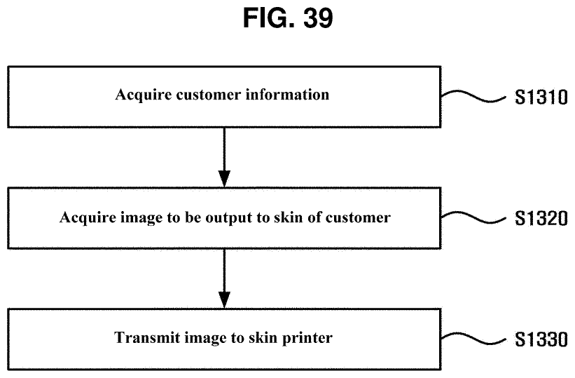

FIG. 38 is a view illustrating a system for providing a marketing service using a skin printer, according to one embodiment.

Referring to FIG. 38, the system includes a server 1200, a customer 1220, a customer client 1210, which is a user client of the customer 1220, a service client 1250 providing a marketing service, and a skin printer 10.

Since components included in the system of FIG. 38 illustrate components according to an embodiment, some components may be omitted from or added to the system.

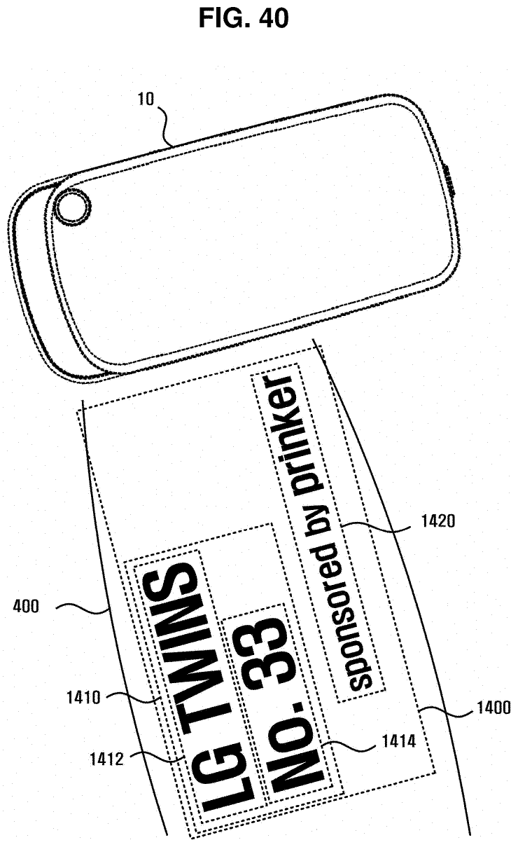

A method for providing the marketing service by a service client 1250 using the skin printer 10 will be described using the flowchart of FIG. 39.

According to an embodiment, the service client 1250 and the server 1200 refers to a computer or a program running on the computer.

The entire portion or some of the method for providing the marketing service using the skin printer according to the embodiment disclosed below is performed by the service client 1250 or the server 1200.

According to an embodiment, the service client 1250 downloads a program for performing the method for providing the marketing service using the skin printer according to an embodiment disclosed herein from a server 1200 or another external server, and performs a marketing service using the skin printer using the downloaded program according to an embodiment disclosed herein.

According to an embodiment, the service client 1250 is connected to the server 1200 through a web page, and performs the method for providing the marketing service using the skin printer according to an embodiment disclosed herein through a single page application (SPA) provided from the server 1200.

The above-described embodiments are provided by way of example, and the entire portion or some of a method for providing a marketing service using a skin printer according to the embodiments disclosed below, which is performed by the service client 1250 or the server 1200, is not limited thereto.

Further, steps illustrated in FIG. 39 are performed in time series by the service client 1250 or the server 1200 illustrated in FIG. 38. The following description will be described by separating functions of the service client 1250 or the server 1200. In particular, although the following description will be described in that steps illustrated in FIG. 39 are performed by the service client 1250, the subject of performing each step is not limited to the service client 1250, but the entire portion or some of the steps may be performed by the server 1200.

In step S1310, the service client 1250 obtains customer information from the server 1200.

According to an embodiment, the service client 1250 acquires at least one identifier for the customer 1220 from the customer 1220 or the customer client 1210 and requests the server 1200 to provide customer information using the acquired identifier.

The service client 1250 receives customer information corresponding to the identifier from the server 1200.

According to an embodiment, the identifier may include the name or telephone number of the customer 1220.

In addition, the customer information includes at least one of personal information of the customer 1220 and the preference of the customer 1220 uploaded to the server 1200 by the customer 1220.

For example, the personal information of the customer 1220 may include the name, the age, the birthday, the phone number, the home address, and the mail address. In addition, the information on the preference of the customer 1220 may include information about the customer's interests, a favorite image of the customer, a favorite athlete of the customer, a team the customer cheers, and a favorite entertainer of the customer.

According to an embodiment, the server 1200 may provide the customer client 1210 with one or more questions to acquire information on the preference of the customer. Each of the one or more questions may be provided as a subjective question or a multiple choice question. For example, the one or more questions may include a multiple choice question that allows the customer to select an image that the customer wants to print on the skin.

In step S1320, the service client 1250 acquires at least one image to be output to the skin of the customer 1220.

According to an embodiment, the at least one image includes an image corresponding to at least one of a marketing service, the customer information acquired in step S1310, and a reward to be provided to the customer 1220.

According to an embodiment, the image corresponding to the customer information may include an image corresponding to the preference of the customer.

According to an embodiment, the image corresponding to the reward may include an identification code corresponding to the reward to be provided to the customer. In addition, the identification code may include at least one of a text (e.g., a letter, a number, and the combination of the number or letter) and a two-dimensional code that is able to be scanned.

According to an embodiment, the service client 1250 combines at least one image to generate an image for output.

In step S1330, the service client 1250 transmits the image obtained in step S1320 to the skin printer 10.

According to an embodiment, the service client 1250 transmits, to the skin printer 10, an outputting image generated by combining at least one image acquired in step S1320.

The skin printer 10 outputs the image acquired from the service client 1250 to the skin of the customer 1220.

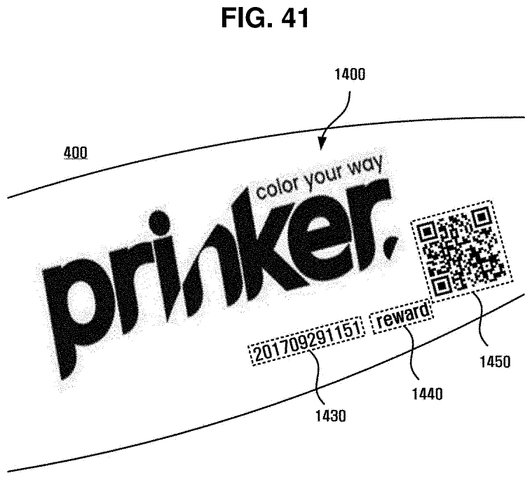

FIGS. 40 and 41 illustrate that the skin printer 10 outputs an image to the body part 400 of the customer 1220, that is, the skin.

FIG. 40 illustrates that the skin printer 10 outputs an image 1400 to the body part 400.

According to an embodiment, the image 1400 is an image created by combining one or more images.

Referring to FIG. 40, the image 1400 includes a plurality of sub images 1410 and 1420.

According to an embodiment, a first sub-image 1410 may be an image corresponding to the preference information of the customer. For example, the first sub-image 1410 may be an image including a sports team 1412 supported by the customer 1220 and a uniform number 1414 of a player who the customer 1220 likes.

In addition, a second sub-image 1420 may be an image corresponding to marketing information including a logo or a product name of a company to be promoted.

Therefore, the customer 1220 allows an image 1420 including marketing information to be output together with an image 1410 such that the image 1410 is output to the skin. Accordingly, a marketing effect allowing the body of the customer 1220 to be a signboard moving may be produced.

FIG. 41 illustrates that an image including reward information is output.

In FIG. 40, the image 1400 includes an image corresponding to the preference of the customer, so that the customer may regard the output of the image on the skin as a reward for marketing.

FIG. 41 illustrates that an image 1400 including an image for marketing as a main image is output on the body part 400 of the customer 1220 by skipping an image corresponding to the preference of the customer and displaying the image corresponding to the preference of the customer as a smaller image.

In this case, since a larger marketing image is displayed on the body of the customer 1220, the promotional effect may be increased. However, a reward may be provided to allow the customer 1220 to output the marketing image to the body of the customer 1220.

According to an embodiment, the reward may be provided immediately after outputting the marketing image to the body of the customer 1220 in the field. However, the reward may be provided at a different place from a place where the marketing image is output, at a different time.

For example, the reward may be a specific gift, and may be to allow a customer to receive foods and a beverage in a cafeteria.

Thus, the image 1400 may further include one or more sub-images 1430, 1440, and 1450 that include reward information.

According to an embodiment, the sub-image including the reward information may include an image 1440 indicating that the reward is to be provided without including any special information.

In this case, the customer 1220 may show a reward image 1440 output to the skin at the place (reward providing place) where the reward is provided. After receiving the reward, the customer 1220 may erase the reward image 1440. The work of erasing the reward image 1440 may be performed by a service provider providing the reward.

According to an embodiment, the reward image 1440 may be printed with ink including a material that automatically disappears after a specific time.

Thus, the reward image 1440 may be erased after a specific time, or to be erased when the reward is provided, such that the customer 1220 may not receive the reward in duplicate.

According to another embodiment, the reward image may include an identification code image 1430 or a scan able two-dimensional code image 1450 in a text form.

For example, whenever the image 1400 is output to the skin of the customer 1220, a new identification code is generated, and the generated identification code is the identification code image 1430 in a text form to be output the skin of the customer 1220.

When the customer 1220 suggests an identification code image 1430 at the reward providing place, a service provider looks up the identification code to determine whether the reward of the customer 1220 is paid. If any reward is not provided to the customer 1220, the service provider may provide a reward to the customer 1220.

According to an embodiment, a marketing service provider may use a means of attracting the customer 1220 to maintain the advertising effect by maintaining the image 1400 long after the reward is provided, without erasing the image 1400.

For example, when a specific time elapsed after the customer 1220 is provided with the reward, the fact that the reward has been provided may be reset, and the customer 1220 may receive a reward using the same identification code once more. A client 1210 queries the identification code and provides, for the customer 1220, the result regarding whether allowable time for re-providing the reward is elapsed.

In addition, a service for providing a prize by drawing one or more identification codes after a specific time is elapsed may be provided by the server 1200 or the service client 1250. Accordingly, a customer 1220 who wants to participate in the draw for winner may not delete the image 1400 until the draw for winner is completed.

In addition, the reward image may include a 2D code image 1450, and the information stored in the 2D code image 1450 may be identification code information or information corresponding to the customer 1220.

The service provider of the reward providing place scans the two-dimensional code image 1450 by using the service client, and obtains identification code information corresponding to the two-dimensional code or whether the reward is provided corresponding to the identification code information. In addition, the service client may scan the two-dimensional code image 1450 and acquire a page including personal information of the customer 1220. The page including personal information of the customer 1220 may include information on the reward received by the customer 1220.

In addition, the identification code may include information on the type of a reward that the customer receives. For example, the service client may retrieve the identification code or scan the two-dimensional code, and may acquire reward information corresponding to the two-dimensional code from the server 1200.

For example, rewards may vary from person to person, and may be differentially provided based on at least one of the type, size, and the number of images output to the skin.

For example, as a larger image is output to the skin, the advertisement effect is more increased. Accordingly, the greater reward may be provided. Similarly, when more many images are output, the greater reward may be provided.

In addition, it is possible to acquire information on the time when the image is output to the skin by using the identification code or the two-dimensional code corresponding to the reward information. In this case, as it is determined that a customer maintains the skin having an image for a longer time, a greater reward may be provided to the customer.

The following description will be described in detail regarding a scenario of outputting an advertisement image to a body of a customer 1220 using the skin printer 10 and providing a reward, or of providing a marketing service in a manner of outputting an advertisement together with an image desired by the customer 1220.

For example, at a ballpark, the customer 1220 obtains information on the position of a promotional booth having the skin printer 10 by using a customer client 1210. For example, the customer client 1210 acquires information on the position of the promotional booth and provides the information for the customer 1220 by using a GPS, a network, an ultrasound, and a BLE. The customer 1220 selects a desired image using the customer client 1210 or transmits information on a favorite team and a baseball player to the server 1200.

A promotion agent receives customer information from the customer client 1210 through Bluetooth or a network, and outputs an image corresponding to the received information to the body of the customer 1220 using the skin printer 10.

According to an embodiment, the customer 1220 may upload the information to the server 1200 using the customer client 1210, and the two-dimensional code corresponding to the uploaded information may be displayed on the customer client 1210 of the customer 1220. The promotion agent may acquire information on the customer 1220 by scanning the two-dimensional code displayed on the customer client 1210.

A reward may be an image itself to output to the customer 1220, and a separate reward (goods) may be provided.

For example, the customer 1220 may receive a reward in the field after outputting the image to the body, or may receive the reward by suggesting the image at another place.

In this case, an image including an identification code, such as a 2D code, a numeric value, or an image, for determining whether the reward is provided, may be output to the body to prevent the reward from being provided doubly.

For example, it may be determined whether the reward is provided by scanning the two-dimensional code output to the body when the reward is provided, or may be determined whether the reward is provided by using the personal information of the customer 1220.

In addition, an image representing a reward (e.g., a small cup image) is displayed when outputting the image, and actually deleted when the reward is provided, thereby displaying whether the reward is provided.

According to an embodiment, rewards may be differentially provided depending on the size and the number of images output to the customer 1220.

To use the above-described marketing service method, the advertiser requests a promotion to a promotion company, and pays rewards and promotion costs depending on public relations. The promotion company stores the personal information of each customer 1220 collected from the customers 1220 in a database while processing the promotion using the skin printer 10. The server 1200 automatically stores collected information in a database to be managed.

The promotion company may also manage the information collected from customers 1220, print information, and reward providing information through a computer, to provide a feedback to an advertiser by quantitatively evaluating the performance according to the promotion. According to an embodiment, the feedback may be automatically generated and provided by the server 1200.

In addition, personal information, such as the preference of each customer 1220, may be acquired based on information on a favorite team or baseball player mentioned in the above-described embodiment, and an image output on the body.

The promotion company or the advertiser may manage the obtained information in a database, and may be used to determine retargeting for future promotions and marketing content for each customer 1220.

To this end, the service client 1250 transmits, to the server 1200, feedback including a result of marketing performed for the customer 1220. For example, the service client 1250 acquires or generates an image of the customer 1220, transmits the image to the skin printer 10, and transmits, to the server 1200, information on that the marketing of the customer 1220 has been performed.

According to an embodiment, the service client 1250 may receive information indicating that image output is completed from the skin printer 10. In this case, when the image output completion information is received from the skin printer 10, the service client 1250 may transmit a marketing completion signal for the customer 1220 to the server 1200.

The server 1200 may generate and store a database including customer information of the customer 1220 and feedback to the customer 1220.

According to an embodiment, the server 1200 may generate a result obtained by performing the marketing service according to the disclosed embodiment based on the database. For example, the result includes statistics on a customer, to who marketing is performed, depending on a marketing service according to the disclosed embodiment. For example, the result may include statistical about the number of customers, to who marketing is performed, and the age or gender of the customer, and statistical information on the number of provided rewards.

According to an embodiment, the server 1200 generates a next marketing strategy for at least one customer included in the database. The server 1200 generates the next marketing strategy based on the information on the preference of each of the at least one customer. For example, the server 1200 may transmit, to each customer, information on the next game schedule or the next event which the customer likes, by using information on the favorite team of the customer.

In addition, the server 1200 may generate a list of at least one customer to provide next marketing services using a database, and provide next marketing services for at least one customer included in the generated list.

For example, to provide a marketing service for a specific baseball team, the server 1200 may provide a marketing service according to the embodiment disclosed herein in a stadium where a game of a specific baseball team is performed. In this case, the number of fans of the opponent baseball team other than fans of the specific baseball team may be considerable in the stadium. Therefore, the marketing is performed with respect to all customers once, and the server 1200 may perform re-targeting with respect to only customers who like a specific baseball team based on acquired information in the marketing proceeding procedure.

The server 1200 may transmit marketing information on a specific baseball team to customers included in the list of re-targeted customers.

According to an embodiment, the method for outputting the two-dimensional code or identification information to the skin described above, may also be utilized to manage livestock. For example, it is possible to manage information on each livestock without a separate tag by outputting a two-dimensional code to the skin of the livestock.

According to another embodiment, the skin printer 10 may be used to output a circuit using metallic ink. For example, the skin printer 10 may be used to manage livestock by printing RFID or NFC circuits/tags on the skin of the livestock using metallic ink.

For example, the skin printer 10 may output a circuit using not only metallic ink but also ink including various conductive materials such as graphene and conductive polymer.

According to an embodiment, an open market service that may share and trade an image output from the skin printer 10 may be provided.

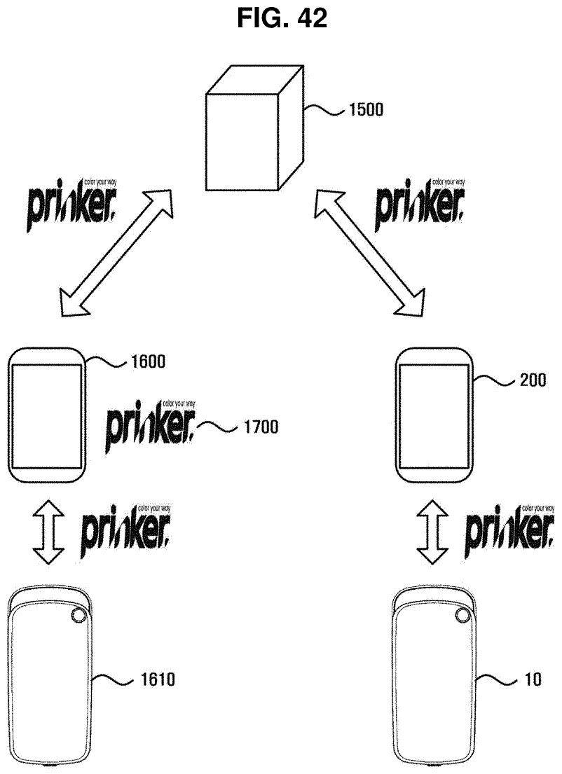

FIG. 42 is a view illustrating an open market service system for sharing and trading an image output from a skin printer according to one embodiment.

For example, an image 1700 created by a creator may be transmitted to a server 1500 by a creator client 1600, posted in an open market (or online store) running on the server 1500 or an external server, and shared or sold to other users. Another user may purchase an image from the open market using a user client 200 and output the purchased image using the skin printer 10.

The image posted in the open market may include a watermark to prevent illegal download, the skin printer 10 may be configured to output only an image which is officially purchased and downloaded. As another example, at least one code for authenticating that the image is formally purchased may be included in the image file or may be included in the image in the form of cryptography. The skin printer 10 may output the image only when the code authentication is successful, or may output the phrase “Illegally downloaded image” together with the image when the code authentication fails.

According to an embodiment, the image is divided into a single path output image and an image that may be output when a multipath output function is provided. Accordingly, the images are selectively retrieved and purchased depending on the device or the infrastructure of each user.

In addition, a company that outputs a tattoo image on the skin using the skin printer 1610 according to an embodiment disclosed herein may be generated. In this case, the open market may guide even a person who does not have a skin printer or a person who does not have a multipath device, to a company that may receive the printout of a specific image.

In addition, each company may create and upload their own signature image, but does not sell the image itself, and may perform promoting a customer to visit a store and to receive the printout of the image in an online store.

Images sold in the online store may be provided at a differential prices according to the authority. For example, authorities are classified depending on an image allowing only one printout, an image allowing several printouts, an image allowing a printout for a specific period of time, an image allowing infinite printouts, an image depending on a particular skin printer, an image allowing a printout in a plurality of printers, and an image utilized for commercial purposes in a tattoo shop.

In addition, a usage right may be purchased to allow a user to pay for an image depending on the number of printouts or to freely print out the image for a specific period of time, similarly to music streaming.

Thus, the operations of the methods or algorithms described in connection with the embodiments disclosed in the inventive concept may be directly implemented with a hardware module, a software module, or the combinations thereof, executed by the hardware. A software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer readable recording medium well known in the art to which the inventive concept pertains.

According to the inventive concept, when printing is performed on the skin, the printer housing is maintained at a specific distance from the skin by the spacing roller to prevent the printing solution from spreading on the skin, and to print the image on the skin similarly to the original image.

According to another embodiment of the inventive concept, when printing is performed on the curved portion of the skin, the nozzle of the cartridge may be prevented from contacting the skin, defects may be prevented in the printed image, and the deterioration of print quality may be prevented

According to another embodiment of the inventive concept, there may be possible skin printing that glows in a dark space, such as a club, at night.

According to another embodiment of the inventive concept, the multipath function is provided to output a larger image that cannot be output using a single path function, to a wide area of the body.

According to another embodiment of the inventive concept, the user may be guided to output the image in the correct position.

In addition, according to the disclosed embodiment, there may be provided the marketing service in which the type of the image is not limited using the skin printer, and the image obtained by reflecting the preference of the customer and the marketing purpose are output to the skin of the customer to produce the advertisement effect.

In addition, since the statistics of the customers to who the marketing is performed and information on each customer are obtained, the effect of the marketing may be quantitatively obtained.

In addition, the information on the customer to who the marketing may be performed is stored in the database, and may be utilized for re-marketing for the next marketing service.

Although embodiments of the inventive concept have been described with reference to accompanying drawings, those skilled in the art should understand that various modifications are possible without departing from the technical scope of the inventive concept or without changing the subject matter of the inventive concept. Therefore, those skilled in the art should understand that the technical embodiments are provided for the illustrative purpose in all aspects and the inventive concept is not limited thereto.

What is claimed is:

1. A skin printer comprising:
a printer housing including a receiving part to receive a plurality of cartridges having a nozzle to discharge a printing solution including at least one of an ink, a coating agent, a fragrant material, and a fluorescent substance or a combination of the ink, the coating agent, the fragrant material, and the fluorescent substance, and a plurality of discharge holes to discharge the printing solution from nozzles of the plurality of cartridges received in the receiving part;
a main roller rollably provided in the printer housing to guide movement of the printer housing along a skin; and
at least one spacing roller interposed between the discharge holes paired to be adjacent to each other to space the printer housing to the skin, and to roll along the skin together with the main roller.

2. The skin printer of claim 1, wherein a rolling surface of the skin printer disposed on a printing path of the printing solution discharged from the nozzle of the cartridge has a roughness.

3. The skin printer of claim 1, wherein a rolling surface of each of the main roller and the spacing roller is subject to resist printing.

4. The skin printer of claim 1, further comprising:
a cleaning unit provided at an upper end of each of the main roller and the spacing roller to remove a pollutant from a surface of each of the main roller and the spacing roller.

5. The skin printer of claim 1, further comprising:
a cover movably provided in the printer housing to reciprocate between a first position for closing the discharge hole and a second position for opening the discharge hole.

6. The skin printer of claim 5, further comprising:
a plurality of caps provided corresponding to the plurality of discharge holes and provided in the cover to open or close the plurality of discharge holes as the cover reciprocate.

7. The skin printer of claim 5, further comprising:
a plurality of wiping parts provided in the cover and corresponding to the plurality of discharge holes to make contact with the nozzle of the cartridge, which is exposed through the discharge hole as the cover reciprocates, while cleaning the nozzle of the cartridge.

8. The skin printer of claim 7, wherein the wiping part has an upper end formed in a shape of a hook to remove a foreign matter.

9. The skin printer of claim 1, further comprising:
a sealing member provided in the discharge hole to maintain airtightness between the nozzle of the cartridge and the discharge hole.
